(19) United States
(12) Patent Application Publication
(10) Pub. No.: US 2008/0320395 A1
(43) Pub. Date: Dec. 25, 2008

(54) Electronic apparatus, an imaging apparatus, a display control method for the same and a program which allows a computer to execute the method

(75) Inventor: Hiromichi Yuasa, Aichi (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/999,002

(22) Filed: Dec. 3, 2007

(30) Foreign Application Priority Data
Dec. 5, 2006 (JP) P2006-328861

(51) Int. Cl. G06F 15/16; G06F 3/048

(52) U.S. Cl. 715/735; 709/227

(57) ABSTRACT

An electronic apparatus is disclosed. The electronic apparatus may include a plurality of terminals that output a predetermined item of information; a connecting appliance selecting means for selecting a type of another electronic apparatus to be a target for connection among other electronic apparatuses having a terminal connectable to at least a single terminal among the plurality of the terminals through a predetermined communication means; a connecting terminal selecting means for selecting a combination of terminals used for connection from combinations of terminals provided on the electronic apparatus and terminals provided on the selected type of another electronic apparatus; and a setting detail deciding means for deciding setting details of output to the another electronic apparatus in accordance with the type of the selected another electronic apparatus and the combination of the terminals.

### CROSS-REFERENCE TO RELATED APPLICATIONS

This application claims priority from Japanese Patent Application No. JP 2006-328861 filed in the Japanese Patent Office on Dec. 5, 2006, the entire content of which is incorporated herein by reference.

### BACKGROUND OF THE INVENTION

1. Field of the Invention

The present invention relates to an electronic apparatus, particularly to an electronic apparatus having a plurality of connecting terminals, an imaging apparatus, a display control method for the same, and a program which allows a computer to execute the method.

2. Description of the Related Art

Heretofore, imaging apparatuses such as a digital video camera have high photographable resolution and the number of pixels becomes greater. In addition, in association with the start of terrestrial digital broadcast in television broadcast, in stead of standard definition (SD) for the image quality of television sets before, high definition (HD) becomes popular that is the high definition image quality of terrestrial digital broadcast.

In addition, heretofore, it is widely performed that images taken by an imaging apparatus are outputted to a television set having a big screen display and seen thereon. For example, in the case in which images taken by an imaging apparatus are outputted to a television set and seen thereon, it is necessary to connect the output terminals of the imaging apparatus to the input terminals of the television set. Moreover, for the input terminal provided on the television set before, a composite terminal is widely used.

However, in recent years, imaging apparatuses and television sets provide images of higher quality, and in order to allow high quality images to be seen, such a television set is widely available that has a plurality of types of input terminals such as a component terminal, i.LINK (trademark) terminal, and HDMI (trademark) terminal. In addition, such an imaging apparatus is proposed that has a plurality of output terminals in order to support the input terminals of a television set.

For example, a video output apparatus is proposed in which various video signals compliant to a plurality of types of video signals and a plurality of television systems are outputted through a single video output terminal (for example, see Patent Reference 1 (JP-A-2005-109553 (FIG. 1))).

### SUMMARY OF THE INVENTION

According to the technique before, in the case in which the video output apparatus is connected to a television monitor of the NTSC/PAL system or a television monitor of the high definition system, the apparatus can be connected to the same video output terminal through a cable connected to various television monitors.

However, for example, depending on types of television sets to be a target for connecting to the video output apparatus, some of television sets are necessary to set the output format and the reproduction format in advance on the video output apparatus side. On this account, for example, in the case in which an imaging apparatus such as a digital video camera is connected to a television set, when they are connected to each other through a cable with no settings described above, video is not sometimes outputted correctly and video is not sometimes outputted in desired image quality on the television set.

As described above, for example, in the case in which video taken by an imaging apparatus such as a video camera is seen on a television set, it is necessary for a user to know items to set the output format to perform predetermined setting operations and then to connect the imaging apparatus to the television set. Therefore, for a user who is not used to manipulating the imaging apparatus and the television set, it is usually difficult to do setting manipulations relating to connection. As described above, in the case in which an electronic apparatus such as an imaging apparatus is connected to another electronic apparatus such as a television set, it is preferable that a user who is not used to manipulating these appliances can readily connect the appliances to each other.

Thus, it may be desirable to facilitate connecting appliances to each other in the case in which an electronic apparatus is connected to another electronic apparatus.

An embodiment of the invention is an electronic apparatus which may include a plurality of terminals that output a predetermined item of information; a connecting appliance selecting means for selecting a type of another electronic apparatus to be a target for connection among other electronic apparatuses having a terminal connectable to at least a single terminal among the plurality of the terminals through a predetermined communication means; a connecting terminal selecting means for selecting a combination of terminals used for connection from combinations of terminals provided on the electronic apparatus and terminals provided on the selected type of another electronic apparatus; and a setting detail deciding means for deciding setting details of output to the another electronic apparatus in accordance with the type of the selected another electronic apparatus and the combination of the terminals, and a display control method of the same and a program which allows a computer to execute the method. Accordingly, such an advantage may be provided such that a type of another electronic apparatus to be a target for connection is selected, the combination of the terminals used for connection is selected from the combinations of the terminals provided on the appliance and the terminals provided on the selected type of another electronic apparatus, and the setting details of output to the selected another electronic apparatus are decided in accordance with the type of the selected another electronic apparatus and the combination of the terminals.

In addition, in the electronic apparatus, the appliance may further include: a display means for displaying various screens; and a display control means for displaying a connecting device selection screen for selecting the another electronic apparatus on the display means and for displaying a connecting terminal selection screen for selecting a combination of terminals provided on the electronic apparatus and terminals provided on the selected type of another electronic apparatus on the display means, wherein the connecting appliance selecting means selects a type of another electronic apparatus to be a target for connection among other electronic apparatuses displayed on the connecting device selection screen, and the connecting terminal selecting means selects a combination of terminals used for connection from combinations of terminals displayed on the connecting terminal selection screen. Accordingly, such an advantage may be provided such that a type of another electronic apparatus to be a target for connection is selected among the other electronic apparatuses displayed on the connecting device selection screen and the combination of the terminals used for connection is selected from the combinations of the terminals displayed on the connecting terminal selection screen.

In addition, in the electronic apparatus, the display control means may allow the display means to display a connection instruction screen that displays the appearance of terminals for the selected combination and the appearance of a communication means connectable to these terminals to encourage connection of these terminals to the communication means. Accordingly, such an advantage may be provided that the connection instruction screen is displayed that displays the appearance of terminals for the selected combination and the appearance of a communication means connectable to these terminals to encourage connection of these terminals to the communication means.

In addition, in the electronic apparatus, the display control means may allow the display means to display a connection state confirm screen that encourages confirmation of a connection state between the electronic apparatus and the selected another electronic apparatus connected through the terminals and the communication means displayed on the connection instruction screen. Accordingly, such an advantage may be provided that the connection state confirm screen is displayed that encourages confirmation of the connection state between the electronic apparatus and the another electronic apparatus connected through the terminals and the communication means displayed on the connection instruction screen.

In addition, in the electronic apparatus, on the connection instruction screen, the appearance of the electronic apparatus and the appearance of the selected another electronic apparatus may be displayed as well as the appearance of the terminals and the appearance of the communication means. Accordingly, such an advantage may be provided that on the connection instruction screen, the appearance of the electronic apparatus and the appearance of the selected another electronic apparatus may be displayed as well as the appearance of the terminals and the appearance of the communication means.

In addition, in the electronic apparatus, the display control means may allow the display means to display a setting detail display screen that displays the setting details decided by the setting detail deciding means to allow a user to confirm the setting details. Accordingly, such an advantage may be provided that the decided setting details are display to allow a user to confirm the details.

In addition, in the electronic apparatus, the display means may be a touch panel that displays select buttons for guiding a user to a predetermined screen on various screens. Accordingly, such an advantage may be provided that the select buttons for guiding a user to a predetermined screen on various screens are displayed on the touch panel.

In addition, in the electronic apparatus, the display control means may display a hint screen that displays hint information to be information about details displayed on the touch panel based on pressing a select button displayed on the touch panel. Accordingly, such an advantage may be provided that hint information is displayed that is information about details displayed on the touch panel based on pressing a select button displayed on the touch panel.

In addition, in the electronic apparatus, the display control means may display a guide screen that displays a select button for the purpose of at least manipulation to guide a user to the connecting device selection screen on the touch panel. Accordingly, such an advantage may be provided that the guide screen is displayed that displays a select button for the purpose of at least manipulation to guide a user to the connecting device selection screen on the touch panel.

In addition, in the electronic apparatus, on a start screen of the touch panel, a guide button may be displayed that is a select button to go to the guide screen. Accordingly, such an advantage may be provided that on the start screen of the touch panel, the guide button is displayed that is a select button to go to the guide screen.

In addition, in the electronic apparatus, on the connecting terminal selection screen, descriptions relating to terminals provided on the electronic apparatus and terminals provided on the selected type of another electronic apparatus may be displayed. Accordingly, such an advantage may be provided that on the connecting terminal selection screen, the descriptions relating to the terminals provided on the electronic apparatus and the terminals provided on the selected type of another electronic apparatus are displayed.

In addition, in the electronic apparatus, the predetermined item of information may be video information or audio information. Accordingly, such an advantage may be provided that a predetermined item of information for output is video information or audio information.

In addition, in the electronic apparatus, a detecting means may be further included for detecting an event that a communication means is connected to at least a single terminal among the plurality of the terminals, wherein the display control means allows the display means to display the connecting device selection screen when the connection of a communication means is detected by the detecting means. Accordingly, such an advantage may be provided that the connecting device selection screen is displayed when the connection of a communication means is detected by the detecting means.

In addition, an electronic apparatus according to an embodiment of the invention is an electronic apparatus which may include a plurality of terminals to which a predetermined item of information is input; a connecting appliance selecting means for selecting a type of another electronic apparatus to be a target for connection among other electronic apparatuses having a terminal connectable to at least a single terminal among the plurality of the terminals through a predetermined communication means; a connecting terminal selecting means for selecting a combination of terminals used for connection from combinations of terminals provided on the electronic apparatus and terminals provided on the selected type of another electronic apparatus; and a setting detail deciding means for deciding setting details of input to the another electronic apparatus in accordance with the type of the selected another electronic apparatus and the combination of the terminals, and a display control method of the same and a program which allows a computer to execute the method. Accordingly, such an advantage may be provided that a type of another electronic apparatus to be a target for connection is selected, the combination of the terminals used for connection is selected from the combinations of the terminals provided on the electronic apparatus and the terminals provided on the selected type of another electronic apparatus, and the setting details of input from the selected another electronic apparatus are decided in accordance with the type of the selected another electronic apparatus and the combination of the terminals.

In addition, an imaging apparatus according to an embodiment of the invention is an imaging apparatus which may include a plurality of terminals that output a predetermined item of information; a connecting appliance selecting means for selecting a type of another electronic apparatus to be a target for connection among other electronic apparatuses having a terminal connectable to at least a single terminal among the plurality of the terminals through a predetermined communication means; a connecting terminal selecting means for selecting a combination of terminals used for connection among combinations of terminals provided on the imaging apparatus and terminals provided on the selected type of another electronic apparatus; and a setting detail deciding means for deciding setting details of output to the another electronic apparatus in accordance with the type of the selected another electronic apparatus and the combination of the terminals, and a display control method of the same, and a program which allows a computer to execute the method. Accordingly, such an advantage may be provided such that a type of another electronic apparatus to be a target for connection is selected, the combination of the terminals used for connection among the combinations of the terminals provided on the imaging apparatus and the terminals provided on the selected type of another electronic apparatus, and the setting details of output to the selected another electronic apparatus are decided in accordance with the type of the selected another electronic apparatus and the combination of the terminals.

According to the embodiments of the invention, an excellent advantage may be exerted that connecting appliances can be made easier in the case in which an electronic apparatus is connected to another electronic apparatus.

### BRIEF DESCRIPTION OF THE DRAWINGS

FIG. 1 shows a block diagram depicting an exemplary functional configuration of an imaging apparatus 100 according to an embodiment of the invention;

FIG. 2 shows a block diagram depicting an exemplary functional configuration of the display control of the imaging apparatus 100 according to an embodiment of the invention;

FIG. 3 shows a perspective view depicting the appearance of the imaging apparatus 100;

FIG. 4 shows a diagram depicting an exemplary transition of the display screens displayed on a touch panel 140 for setting manipulations on the imaging apparatus 100;

FIG. 5 shows a diagram depicting an exemplary transition of the display screens displayed on the touch panel 140;

FIG. 6 shows a diagram depicting an exemplary display of the display screen displayed on the touch panel 140;

FIG. 7 shows a diagram depicting an exemplary display of the display screen displayed on the touch panel 140;

FIG. 8 shows a diagram depicting an exemplary display of the display screen displayed on the touch panel 140;

FIG. 9 shows a diagram depicting an exemplary display of the display screen displayed on the touch panel 140;

FIG. 10 shows a diagram depicting an exemplary display of the display screen displayed on the touch panel 140;

FIG. 11 shows a diagram depicting an exemplary display of the display screen displayed on the touch panel 140;

FIG. 12 shows a diagram depicting an exemplary display of the display screen displayed on the touch panel 140;

FIG. 13 shows a diagram depicting an exemplary display of the display screen displayed on the touch panel 140;

FIGS. 14A to 14D show a diagram depicting an exemplary display of the display screen displayed on the touch panel 140;

FIG. 15 shows a diagram depicting an exemplary display of the display screen displayed on the touch panel 140;

FIG. 16 shows a diagram depicting an exemplary display of the display screens displayed on the touch panel 140;

FIG. 17 shows a diagram depicting an exemplary display of the display screens displayed on the touch panel 140;

FIG. 18 shows a diagram depicting an exemplary display of the display screens displayed on the touch panel 140;

FIG. 19 shows a diagram depicting an exemplary display of the display screens displayed on the touch panel 140;

FIG. 20 shows a diagram depicting an exemplary display of the display screens displayed on the touch panel 140;

FIG. 21 shows a diagram depicting an exemplary display of the display screens displayed on the touch panel 140;

FIG. 22 shows a diagram depicting an exemplary display of the display screens displayed on the touch panel 140;

FIGS. 23A to 23G show a diagram depicting an exemplary display of the display screen displayed on the touch panel 140;

FIG. 24 shows a diagram depicting an exemplary display of the display screens displayed on the touch panel 140;

FIG. 25 shows a diagram depicting an exemplary display of the display screens displayed on the touch panel 140;

FIG. 26 shows a diagram depicting an exemplary display of the display screens displayed on the touch panel 140;

FIG. 27 shows a diagram depicting an exemplary display of the display screens displayed on the touch panel 140;

FIG. 28 shows a diagram depicting an exemplary display of the display screens displayed on the touch panel 140;

FIG. 29 shows a diagram depicting an exemplary display of the display screens displayed on the touch panel 140;

FIG. 30 shows a diagram depicting an exemplary display displayed on a connecting device display part 880;

FIG. 31 shows a flow chart depicting the process steps of a terminal connection setting process done by the imaging apparatus 100; and

FIG. 32 shows a block diagram depicting an exemplary functional configuration of the imaging apparatus 100 in the case in which a control terminal 350 is provided on the imaging apparatus 100.

### DETAILED DESCRIPTION

Next, embodiments of the invention will be described in detail with reference to the drawings.

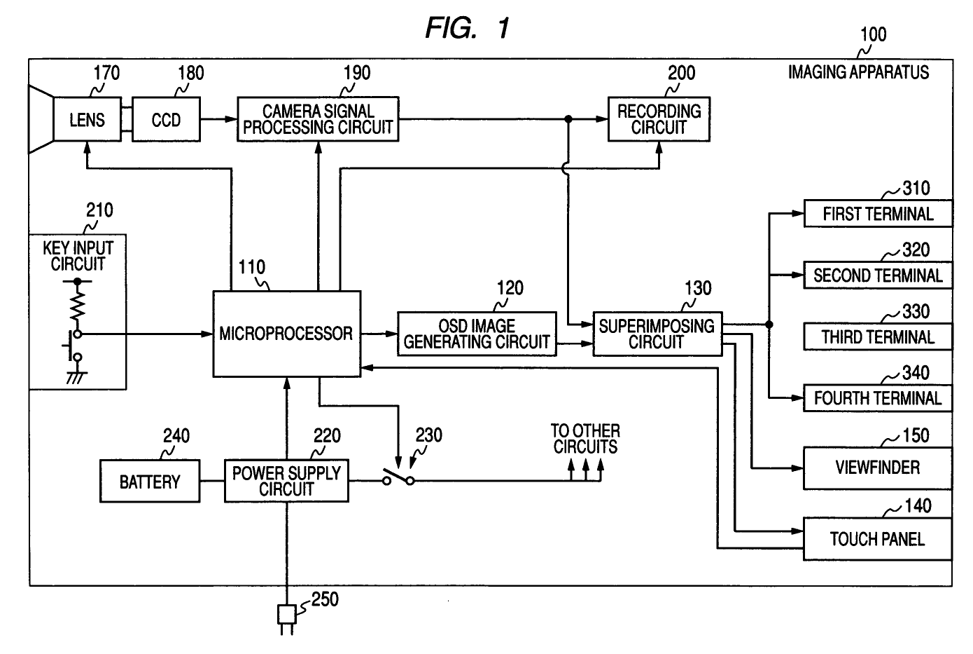

FIG. 1 shows a block diagram depicting an exemplary functional configuration of an imaging apparatus 100 according to an embodiment of the invention. The imaging apparatus 100 is an exemplary electronic apparatus having a plurality of terminals that input or output video information or audio information, which is connected to another electronic apparatus in accordance with an output method desired by a user. Moreover, for another electronic apparatus to be a target for connection, such electronic apparatuses are named including a receiver apparatus such as a television set compliant to the high definition system and an audio visual apparatus, a recording apparatus such as a digital video recorder and a HDD (Hard Disk Drive) recorder and an information input apparatus, and a computer such as a personal computer. In addition, in an embodiment of the invention, output terminals are described but input terminals are also similarly applicable.

The imaging apparatus 100 has a microprocessor 110, an OSD (on-screen display) image generating circuit 120, a superimposing circuit 130, a touch panel 140, a viewfinder 150, a lens 170, a CCD (Charge Coupled Devices) 180, a camera signal processing circuit 190, a recording circuit 200, a key input circuit 210, a power supply circuit 220, a power supply control circuit 230, a battery 240, an AC cable 250, and a first terminal 310 to a fourth terminal 340.

The microprocessor 110 is a microprocessor that controls the individual parts of the imaging apparatus 100 based on a control program stored in a memory (not shown). In addition, the microprocessor 110 determines the pressed state in the touch panel 140 and the key input circuit 210 based on the converted value obtained by subjecting input voltage inputted from the touch panel 140 and the key input circuit 210 to A/D conversion. Then, for example, in the case in which a menu screen is displayed on the touch panel 140, the microprocessor 110 performs processes of selecting and deciding menu items according to the pressed state in the touch panel 140 based on the determined result. In addition, in the case in which a setting screen is displayed on the touch panel 140, the microprocessor 110 performs processes of selecting and deciding set items according to the pressed state on the touch panel 140. Based on these processes, the microprocessor 110 outputs commands to the OSD image generating circuit 120 and the recording circuit 200.

The OSD image generating circuit 120 has a VRAM (Video Random Access Memory) that holds various images displayed on the touch panel 140, and the circuit 120 interprets the command outputted from the microprocessor 110, and outputs display signals matched with image data generated on the VRAM based on the interpreted command in units of scans to the superimposing circuit 130. In addition, the OSD image generating circuit 120 decompresses bitmap data outputted from the microprocessor 110 on the VRAM, and outputs display signals matched with the bitmap data decompressed on the VRAM in units of scans to the superimposing circuit 130.

The superimposing circuit 130 is a superimposing circuit that superimposes video signals outputted from the camera signal processing circuit 190 with the display signals outputted from the OSD image generating circuit 120, and outputs the superimposed image signal to the touch panel 140, the viewfinder 150 and the first terminal 310 to the fourth terminal 340.

The touch panel 140 is a touch panel that displays images matched with the image signals outputted from the superimposing circuit 130 on an LCD (Liquid Crystal Display) panel, converts a touch on the LCD panel into electric signals using a sensor for exclusive use, and outputs the converted electric signals to the microprocessor 110. In addition, the touch panel 140 is a touch panel that displays thereon select buttons to be pressed and selected when a user is guided to a predetermined screen in various screens.

The viewfinder 150 is a display device that displays an image being taken by the imaging apparatus 100 or a reproduced image thereon, and that displays images matched with the image signals outputted from the superimposing circuit 130.

The first terminal 310 is a terminal (LINE OUT) that outputs the image signals outputted from the superimposing circuit 130 to another electronic apparatus. The second the terminal 320 is a terminal (COMPONENT OUT) that outputs the image signals outputted from the superimposing circuit 130 to another electronic apparatus. The third terminal 330 is a terminal (i.LINK OUT) that outputs the image signals outputted from the superimposing circuit 130 to another electronic apparatus. The fourth terminal 340 is a terminal (HDMI OUT) that outputs the image signals outputted from the superimposing circuit 130 to another electronic apparatus.

Moreover, among typical terminals, the component terminal and the multiple jack terminal are terminals that can detect the connection of a communication unit such as a cable, but they are difficult to detect an electronic apparatus to connect. In the case of using these terminals, when an electronic apparatus to connect is detected, it is necessary to provide a control signal to detect the electronic apparatus to connect. In contrast to this, the i.LINK terminal and the HDMI terminal are difficult to detect the connection of a communication unit such as a cable, but they can detect an electronic apparatus to connect by the exchange of control signals between the terminals and the electronic apparatus to connect. Therefore, in the case in which a communication unit such as a cable is connected to the first terminal 310 and the second the terminal 320, the connection is detected. In addition, in the case in which an electronic apparatus is connected through the third terminal 330 and the fourth terminal 340, the electronic apparatus to connect is detected.

The lens 170 collects outside lights and outputs the collected lights to the CCD 180. Moreover, the lens 170 changes an aperture value to control the scale-up of the taken image in accordance with the control signals outputted from the microprocessor 110.

The CCD 180 is an imaging device that converts optical signals inputted through the lens 170 into electric signals and outputs the converted electric signals to the camera signal processing circuit 190.

The camera signal processing circuit 190 is a circuit that applies proper signal processing to the electric signals outputted from the CCD 180 and outputs the electric signals applied to signal processing as video signals to the recording circuit 200 and the superimposing circuit 130. In addition, the camera signal processing circuit 190 performs a process of adding video effects to the video signals in accordance with the control signals outputted from the microprocessor 110. Moreover, for video effects, there are video effects such as negative, sepia tone, and slow shutter.

The recording circuit 200 is a recording circuit that records the video signals outputted from the camera signal processing circuit 190 on a recording medium in accordance with the control signals outputted from the microprocessor 110.

The key input circuit 210 is a circuit that has a single or a plurality of external manipulating members and outputs input voltage to the microprocessor 110 in response to a manipulation of the external manipulating member. This manipulation of the external manipulating member allows control over a plurality of functions provided on the imaging apparatus 100. Moreover, the external manipulating member is a hard key provided on the imaging apparatus 100.

The power supply circuit 220 is a power supply circuit that supplies power to the microprocessor 110 and the other circuits. Moreover, the supply source of power is the battery 240 or the AC cable 250.

The power supply control circuit 230 is a circuit that operates to supply or not to supply power to the other circuits in accordance with the control signals outputted from the microprocessor 110.

The battery 240 is a battery that supplies power to the power supply circuit 220. In addition, the power supply circuit 220 uses electric power supplied from the AC cable 250 to charge the battery 240.

The AC cable 250 is an AC cable that supplies power to the power supply circuit 220. In addition, the AC cable 250 supplies power to charge the battery 240.

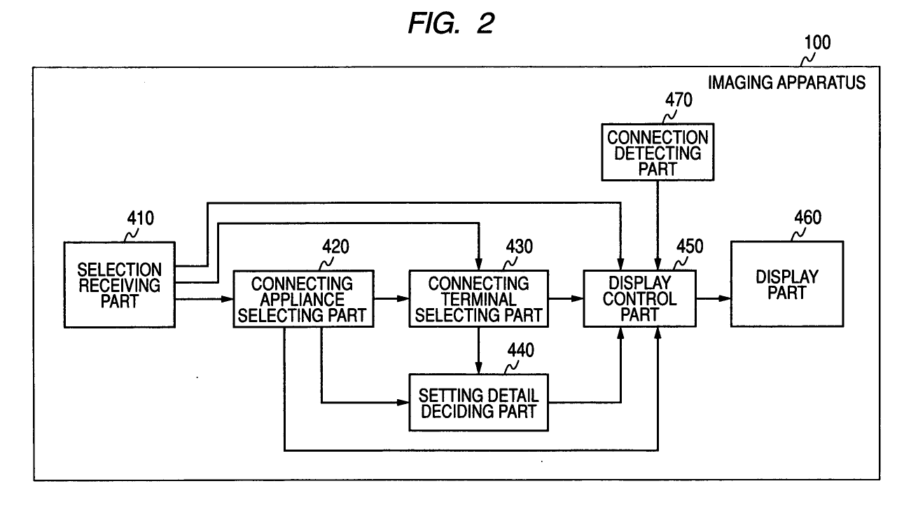

FIG. 2 shows a block diagram depicting an exemplary functional configuration of the display control of the imaging apparatus 100 according to an embodiment of the invention.

The imaging apparatus 100 has a selection receiving part 410, a connecting appliance selecting part 420, a connecting terminal selecting part 430, a setting detail deciding part 440, a display control part 450, a display part 460, and a connection detecting part 470.

The selection receiving part 410 receives various items of information inputted by a user, and then outputs these various items of information to the connecting appliance selecting part 420, the connecting terminal selecting part 430 and the display control part 450. For example, the selection receiving part 410 corresponds to the touch panel 140.

The connecting appliance selecting part 420 is a unit that selects a type of another electronic apparatus to be a target for connection among the other electronic apparatuses displayed on a connecting device selection screen shown on the display part 460 based on select information outputted from the selection receiving part 410. Then, the selection receiving part 410 outputs information about the selected another electronic apparatus to the connecting terminal selecting part 430, the setting detail deciding part 440 and the display control part 450. For example, for the types of another electronic apparatus, a television set compliant to the high definition system and the other television sets, a recorder apparatus, a personal computer and a printer are named.

The connecting terminal selecting part 430 is a unit that selects the combination of the terminals used for connection from the combinations of the terminals provided on the imaging apparatus 100 with the terminals provided on another electronic apparatus outputted from the connecting appliance selecting part 420 displayed on a connecting terminal selection screen shown on the display part 460 based on select information outputted from the selection receiving part 410. Then, the connecting terminal selecting part 430 outputs information about the combination of the selected terminals to the setting detail deciding part 440 and the display control part 450.

The setting detail deciding part 440 is a unit that decides the setting details of output to another electronic apparatus to be a target for connection depending on information about another electronic apparatus outputted from the connecting appliance selecting part 420 and information about the combination of the terminals outputted from the connecting terminal selecting part 430 and outputs the decided setting details to the display control part 450.

The display control part 450 is a unit that outputs various images to the display part 460 based on various items of information outputted from the selection receiving part 410, the connecting terminal selecting part 430, the setting detail deciding part 440 and the connection detecting part 470. For example, the display control part 450 allows the display part 460 to display the connecting device selection screen for selecting another electronic apparatus to be a target for connection. In addition, the display control part 450 allows the display part 460 to display a connecting terminal selection screen for selecting the combination of the terminals used for connection from the combinations of the terminals provided on the imaging apparatus 100 with the terminals provided on another electronic apparatus outputted from the connecting appliance selecting part 420. Moreover, the display control part 450 allows the display part 460 to display a setting detail display screen for confirming the setting details outputted from the setting detail deciding part 440 by a user. In addition, when the display control part 450 receives information about detecting the connection of a cable from the connection detecting part 470, the display control part 450 allows the display part 460 to display the connecting device selection screen.

The display part 460 is a unit that displays various images based on control done by the display control part 450. For example, the display part 460 corresponds to the touch panel 140.

The connection detecting part 470 is a unit that detects an event that a communication unit is connected to at least a single terminal among a plurality of the terminals provided on the imaging apparatus 100. For example, when a communication unit such as a cable is connected to the first terminal 310 and the second the terminal 320, the connection detecting part 470 detects the connection, and when an electronic apparatus is connected through the third terminal 330 and the fourth terminal 340, the connection detecting part 470 detects the connected electronic apparatus. Then, the connection detecting part 470 outputs the detected result to the display control part 450. Moreover, for example, the individual functions of the connecting appliance selecting part 420, the connecting terminal selecting part 430, the setting detail deciding part 440, the display control part 450 and the connection detecting part 470 can be implemented by the microprocessor 110.

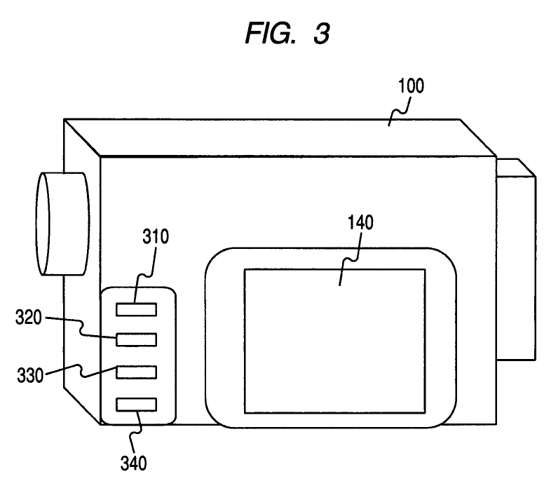

FIG. 3 shows a perspective view depicting the appearance of the imaging apparatus 100.

On the outer side surface of the main body of the imaging apparatus 100, the first terminal (LINE OUT) 310, the second the terminal (COMPONENT OUT) 320, the third terminal (i.L INK OUT) 330, and the fourth terminal (HDMI OUT) 340 are provided that are terminals for connecting to another electronic apparatus and the touch panel 140 is provided. Moreover, the first terminal 310 to the fourth terminal 340 and the touch panel 140 may be provided on the same surface on the outer side surface of the main body of the imaging apparatus 100, or may be provided on different surfaces.

Moreover, from each of the first terminal 310 to the fourth terminal 340, video information or audio information is separately outputted. Thus, any one of the first terminal 310 to the fourth terminal 340 is connected to the terminal of another electronic apparatus through a cable, whereby video information or audio information outputted from the imaging apparatus 100 can be outputted on another electronic apparatus.

However, depending on the electronic apparatus to be a target for connection, it is necessary for some appliances to set the output format and the reproduction format in advance on the imaging apparatus 100. For the reproduction format, for example, there are the DV (Digital Video) and HDV (High-Definition Video [0]) formats. In addition, in the case in which the i. LINK terminal is used to connect to a targeting electronic apparatus to allow the output of video, when the targeting electronic apparatus does not support the HDV format, video is not displayed on the targeting electronic apparatus at all. Furthermore, for example, in the case in which the component terminal is used for connection, when an electronic apparatus to be a target for connection supports the D3 terminal, it is necessary to set the settings of the component output on the imaging apparatus 100 to those of the D3 terminal. On the other hand, in the case in which the electronic apparatus to be a target for connection does not support the D3 terminal, it is necessary to set the settings of the component output on the imaging apparatus 100 to those of the D1 terminal. An exemplary setting method will be described briefly in the case in which the component terminal is used for connection with reference to FIG. 4.

FIG. 4 shows a diagram depicting an exemplary transition of the display screens displayed on the touch panel 140 for setting manipulations on the imaging apparatus 100.

Here, in the case in which the component terminal is used to connect an electronic apparatus not supporting the D3 terminal to the imaging apparatus 100, an exemplary setting method will be described when the settings of the component output on the imaging apparatus 100 are set from “D3” to “D1”. Moreover, the setting method described here is a setting method previously performed.

First, a user presses down a menu button 512 on a display screen 510 of the start screen to display a main menu selection screen 502 of a menu screen on the touch panel 140.

Subsequently, on the main menu selection screen 502, the user presses down an up-scroll button 502a or a down-scroll button 502b to display an indication “preferences” on an item indication 502c. Then, the user presses down an “OK” button 502d in the case in which the indication “preferences” is displayed on the item indication 502c, and a menu list display screen 503 of the indication “preferences” is displayed on the touch panel 140.

Subsequently, on the set item screen 503 of the indication “preferences”, the user presses down an up-scroll button 503a or a down-scroll button 503b to display an indication “component output” on an item indication 503c. Moreover, in the case in which the indication “component output” is displayed on the item indication 503c, an indication “D3” that is the setting details of “component output” is displayed on an area 503d below the item indication 503c. Subsequently, the user presses down an “OK” button 503e in the case in which the indication “component output” is displayed on the item indication 503c, and a setting screen 504 of the indication “component output” is displayed.

On the setting screen 504 of the indication “component output”, since the current setting details are “D3”, one end of a “D3” button 504b is colored. Then, in order to change the set value “D3” to “D1” on the setting screen 504 of the indication “component output”, the user presses down a “D1” button 504a. In this case, as shown in a setting screen 505 of the indication “component output”, one end of the “D1” button 505a is colored. Then, as shown in the setting screen 505 of the indication “component output”, in the case in which one end of the “D1” button 505a is colored, the user presses down an “OK” button 505c to display a set item screen 506 of the indication “preferences”. Moreover, the set item screen 503 and the set item screen 506 are the same screens except that the indication of the display area for the setting details of “component output”.

Moreover, in the case in which the indication “component output” is displayed on an item indication 506c, an indication “D1” that is the setting details of “component output” after changed is displayed in an area 506d below the item indication 506c.

As described above, after the user changes the setting details on the imaging apparatus 100, the user prepares a cable to connect the terminal of an electronic apparatus to be a target for connection to the terminal of the imaging apparatus 100, and then connects the terminal of the electronic apparatus to the terminal of the imaging apparatus 100 with the prepared cable.

As described above, in the case in which the component terminal is used for connection, in doing typical connecting operations, it is necessary for a user to understand the component output and the meanings thereof, and cables to connect the terminal of an electronic apparatus to the terminal of the imaging apparatus 100. On this account, it is difficult for a beginner to do typical connecting operations. In contrast to this, in an embodiment of the invention, a user visually confirms the appearance (shape) of the terminal of the targeting electronic apparatus and the appearance (shape) of the terminal of the imaging apparatus 100, and then selects the terminals to change (set) the set value. Therefore, even a beginner sees the shape of the terminal of the imaging apparatus 100 and the shape of the terminal of the electronic apparatus to connect and then selects the same shapes on the touch panel 140 to change (set) the set value as well as to readily know the cable necessary for connection.

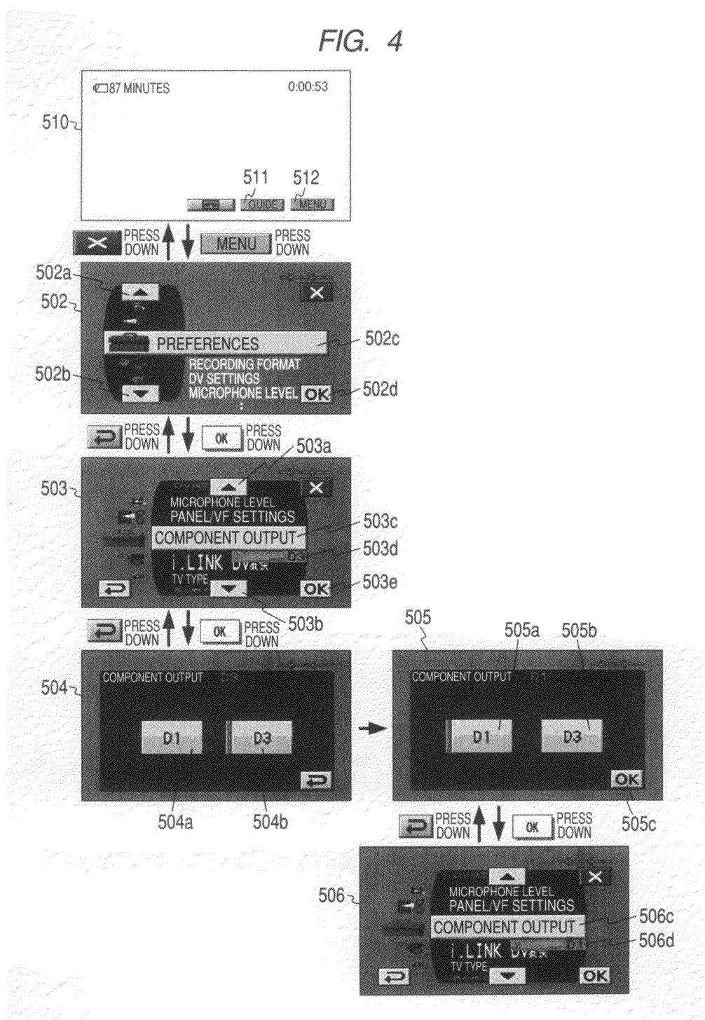

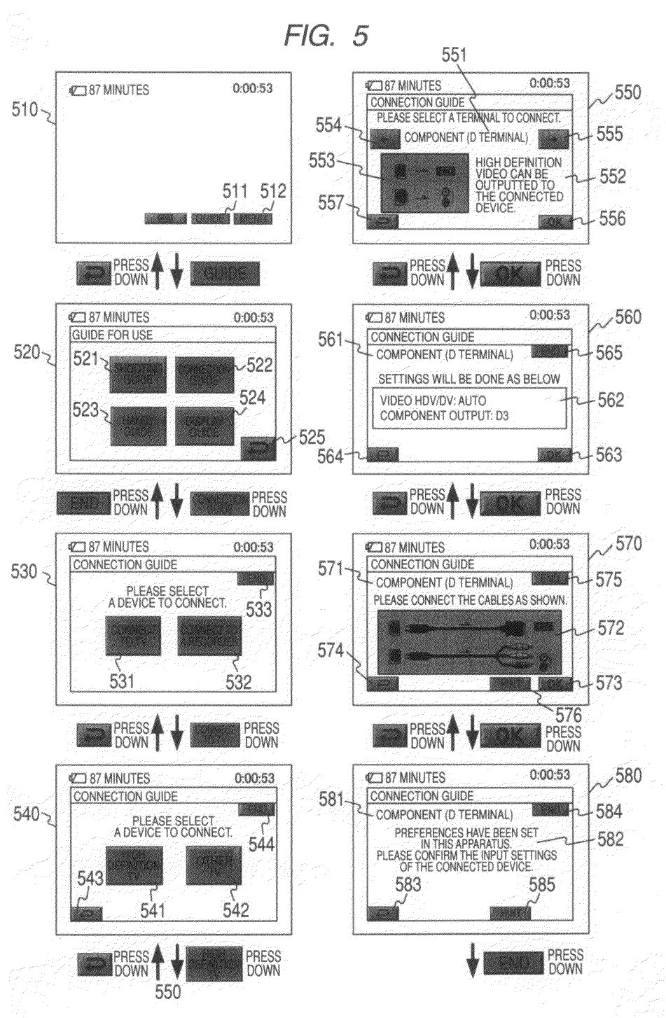

Next, the case in which the imaging apparatus 100 is connected to a high definition television set as an electronic apparatus to connect with the component terminal (D terminal) will be described with reference to FIG. 5 and the other drawings.

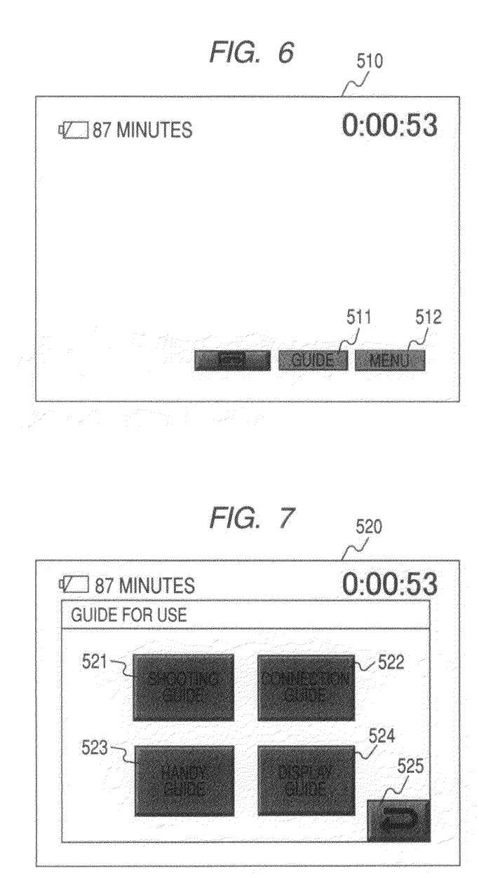

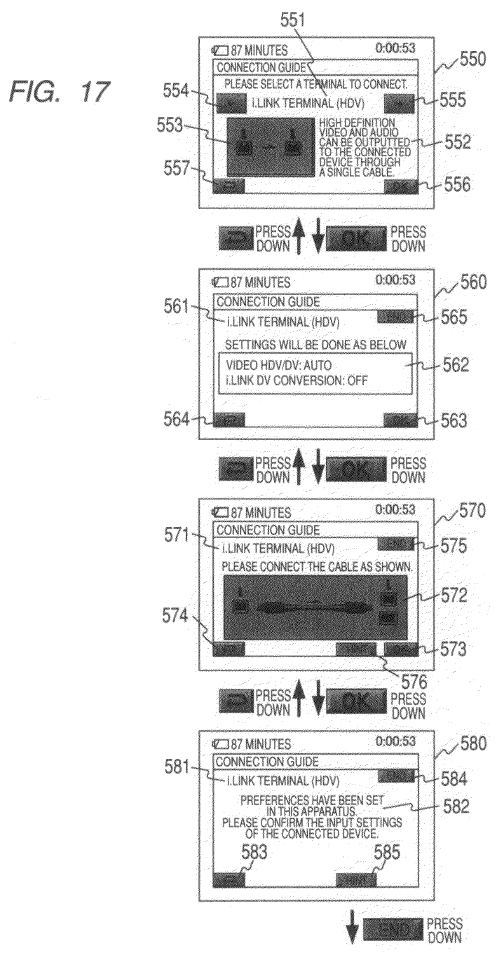

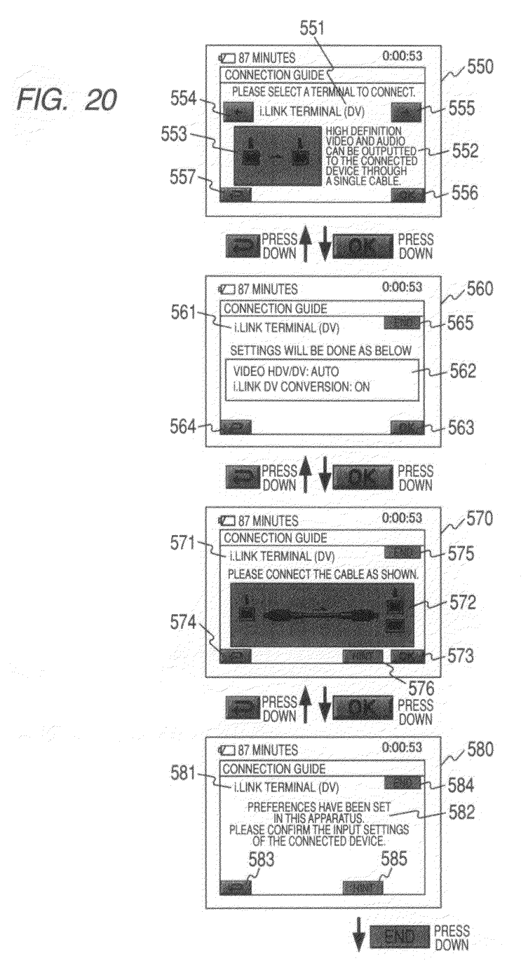

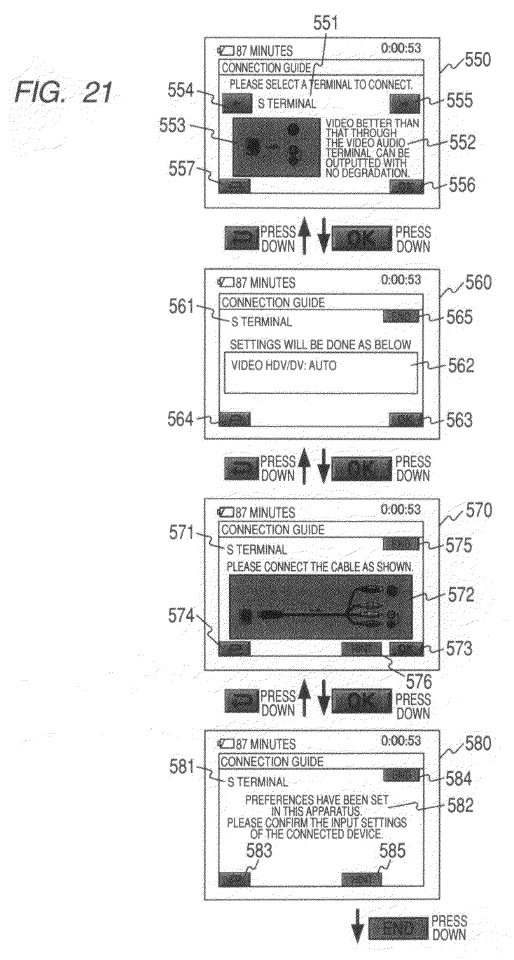

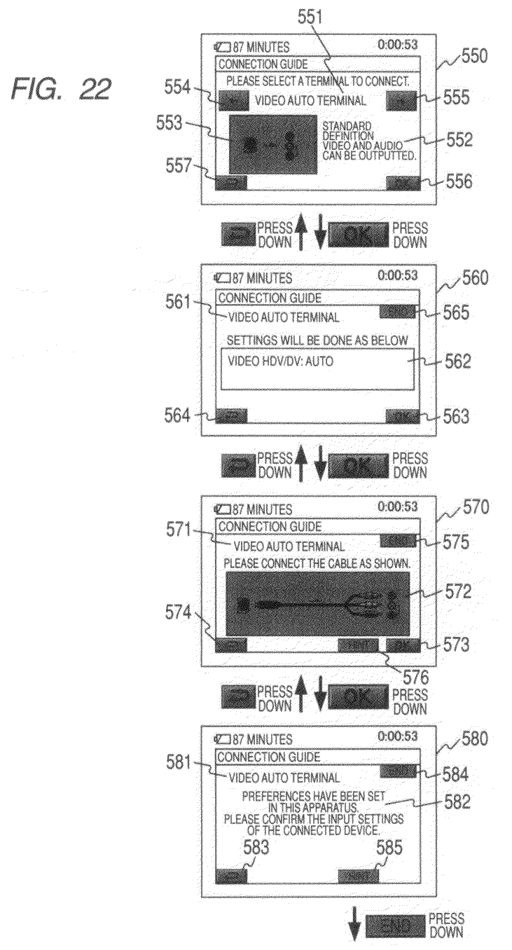

FIG. 5 shows a diagram depicting an exemplary transition of the display screens displayed on the touch panel 140. In addition, FIGS. 6 to 30 show a diagram depicting an exemplary display of the display screen displayed on the touch panel 140.

A display screen 510 shown in FIG. 5 is an the start screen displayed on the touch panel 140 at starting the imaging apparatus 100 (including at power-on) and a screen to be a gate to setting or changing various functions provided on the imaging apparatus 100. Moreover, FIG. 6 shows an enlarged display screen 510. In addition, the display screen 510 shown in FIG. 5 is the same screen as the display screen shown in FIG. 4.

On the display screen 510, a guide button 511 and a menu button 512 is displayed. Moreover, the display screen 510 is a screen that is always displayed after the power supply is started, on which the guide button 511 and the menu button 512 are displayed as well as an image being taken and a reproduced image are displayed.

The guide button 511 is a select button that is a gate to a guide function to be a manipulation assist function to help a user unfamiliar with setting various functions provided on the imaging apparatus 100. The menu button 512 is a select button that is a gate to a menu screen to set various functions by a user making full use of various functions provided on the imaging apparatus 100.

Moreover, the display screen 510 displayed on the touch panel 140 at power-on is a screen that is seen by almost all of users of the imaging apparatus 100. On this account, in the case in which various functions are set, two gates (the guide button 511 and the menu button 512) are provided on the start screen on the touch panel 140, whereby even a user who does not know the existence of the guide function for the manipulation assist function is allowed to recognize the existence of the guide function by intuition.

In the case in which the display screen 510 is displayed on the touch panel 140, when a user sets a desired function, the user presses down any one of the guide button 511 and the menu button 512 to display the setting screen for setting various functions. Moreover, the manipulation when the menu button 512 is pressed is the same as the manipulation before, omitting the discussions here.

The guide button 511 is pressed on the display screen 510, and then a main guide selection screen 520 is displayed on the touch panel 140. Moreover, FIG. 7 shows an enlarged main guide selection screen 520.

The main guide selection screen 520 is a screen that is used to go to a setting screen for setting various functions provided on the imaging apparatus 100 and to various connection screens for connecting another electronic apparatus based on the purposes of manipulations and effects caused by manipulations.

On the main guide selection screen 520, a “shooting guide” button 521, a “connection guide” button 522, a “handy guide” button 523, a “display guide” button 524, and a return button 525 are displayed.

The “shooting guide” button 521 is a select button that is pressed down to go to the setting screen based on the purposes of the manipulations.

The “connection guide” button 522 is a select button that is pressed down to advance the connecting operations for an electronic apparatus to be a target for connection as a user answers questions.

The “handy guide” button 523 is a select button that is pressed down to set a useful function that is relatively easily used.

The “display guide” button 524 is a select button that is pressed down to display help text for describing images of text and symbols displayed on the touch panel 140.

The return button 525 is a button that returns the display screen of the touch panel 140 to the display screen one step before. For example, the return button 525 is pressed down when the main guide selection screen 520 is displayed on the touch panel 140, and then the display screen 510 is displayed on the touch panel 140 which is the display screen one step before. Moreover, the individual return buttons shown in the embodiment of the invention are buttons that return the display screen of the touch panel 140 to the display screen one step before as similar to the return button 525.

Next, the case in which the “connection guide” button 522 is pressed down to do the connecting operations will be described with reference to the drawings.

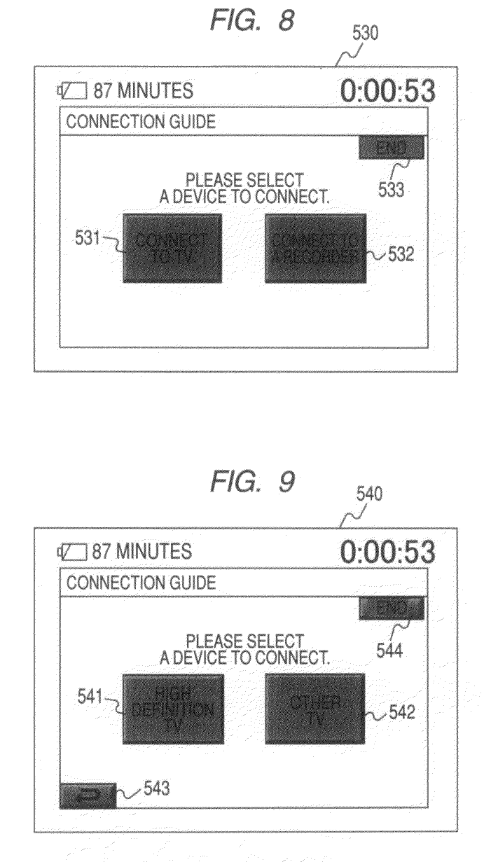

For example, the “connection guide” button 522 is pressed down on the main guide selection screen 520, and then a connecting device selection screen 530 is displayed on the touch panel 140. Moreover, FIG. 8 shows an enlarged connecting device selection screen 530. On the other hand, the return button 525 is pressed down on the main guide selection screen 520, and then the display screen 510 is displayed on the touch panel 140.

The connecting device selection screen 530 is a screen that selects an electronic apparatus to connect by main item select buttons. For example, on the connecting device selection screen 530, a “connect to TV” button 531 to select a television set and a “connect to recorder” button 532 to select a recorder as an electronic apparatus to connect, and an end button 533 are displayed. Moreover, the individual end buttons shown in the embodiment of the invention are buttons that change screens to a general display screen. For example, the end button is pressed down on the screen 530, a screen 540, and screens 560 to 580 shown in FIG. 5, and then the display screen 510 of the start screen is displayed on the touch panel 140.

For example, the “connect to TV” button 531 is pressed down on the connecting device selection screen 530, and then the connect-to-TV select screen 540 is displayed on the touch panel 140. Moreover, FIG. 9 shows an enlarged connect-to-TV select screen 540. On the other hand, the end button 533 is pressed down on the connecting device selection screen 530, and then the display screen 510 is displayed on the touch panel 140.

The connect-to-TV select screen 540 is a screen that selects the type of a television set to connect by the main item select button. For example, on the connect-to-TV select screen 540, a “high definition TV” button 541 to select a high definition television and an “other TV” button 542 to select a television set other than the high definition television as the type of a television set to connect, a return button 543, and an end button 544 are displayed.

Moreover, instead of the “connect to TV” button 531 displayed on the connecting device selection screen 530, the “high definition TV” button 541 and the “other TV” button 542 displayed on the connect to TV select screen 540 may be displayed on the connecting device selection screen 530 to select any one of the “high definition TV” button 541, the “other TV” button 542 and the “connect to recorder” button 532 on the connecting device selection screen 530.

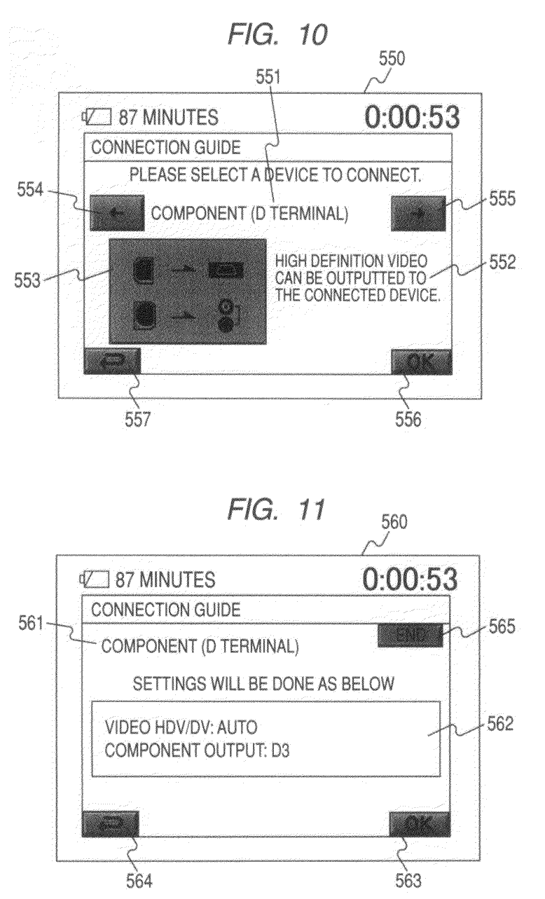

For example, the “high definition TV” button 541 is pressed down on the connect-to-TV select screen 540, and then the connecting terminal selection screen 550 is displayed on the touch panel 140. Moreover, FIG. 10 shows an enlarged connecting terminal selection screen 550. On the other hand, the return button 543 is pressed down on the connect-to-TV select screen 540, and then the connecting device selection screen 530 is displayed on the touch panel 140, whereas the end button 544 is pressed down, and then the display screen 510 is displayed on the touch panel 140.

The connecting terminal selection screen 550 is a screen that selects the terminal of the electronic apparatus to connect and the terminal of the imaging apparatus by a user based on the terminal name, the terminal description and the terminal appearance displayed thereon. For example, on the connecting terminal selection screen 550, a terminal name 551, a terminal description 552, a terminal image 553, a left scroll button 554, a right scroll button 555, an “OK” button 556, and a return button 557 are displayed. Moreover, in an embodiment of the invention, from the combinations of the terminal name 551, the terminal description 552 and the terminal image 553, only a single combination of terminals is displayed on a single screen so that a beginner can easily see and select.

The terminal name 551 is a section that displays the name of the terminal to connect the electronic apparatus to the imaging apparatus 100. For example, an indication “component (D terminal)” is displayed thereon. The terminal description 552 is a section that displays the descriptions of the terminal displayed on the terminal name 551. For example, a message “high definition video can be outputted to the connected device” is displayed thereon.

The terminal image 553 is a section that displays the appearance of the terminal displayed on the terminal name 551. For example, the appearances of the terminal of the imaging apparatus 100 of the output source and the terminal of the electronic apparatus of the input are displayed so as to visually readily know the terminals displayed on the terminal name 551. Moreover, in FIGS. 5 and 10, in the display area of the terminal image 553, the terminals on the left side indicate the terminals of the imaging apparatus 100, and the terminals on the right side indicate the terminals of the electronic apparatus. As described above, in the connecting terminal selection screen 550, since only a single combination of terminals is displayed on a single screen, even a beginner easily see the screen and a user readily select the terminals necessary to use.

The left scroll button 554 and the right scroll button 555 are buttons that scroll and display connecting terminal selection screens other than the connecting terminal selection screen displayed on the touch panel 140. Moreover, all of the left scroll button, the right scroll button, the up-scroll button and the down-scroll button shown in the embodiment of the invention are buttons that scroll and display screens other than the screen displayed on the touch panel 140.

The “OK” button 556 is a button that is pressed down to select the terminal displayed on the connecting terminal selection screen 550.

For example, the “OK” button 556 is pressed down when an indication “component (D terminal)” is displayed on the terminal name 551 on the connecting terminal selection screen 550, and then the set value display screen 560 is displayed on the touch panel 140 in the connection using the indication “component (D terminal)”. Moreover, FIG. 11 shows an enlarged set value display screen 560.

The set value display screen 560 is a screen that displays the optimum set value in accordance with the electronic apparatus selected on the connecting device selection screen 530 or the connect to TV select screen 540 and the terminal selected on the connecting terminal selection screen 550. For example, on the set value display screen 560, a terminal name 561, a set value display part 562, an “OK” button 563, a return button 564, and an end button 565 are displayed.

The terminal name 561 is a section that displays the name of the terminal selected on the connecting terminal selection screen 550. For example, the indication “component (D terminal)” is displayed thereon.

The set value display part 562 is a section that displays the optimum set value in accordance with the electronic apparatus selected on the connecting device selection screen 530 or the connect to TV select screen 540 and the terminal selected on the connecting terminal selection screen 550.

For example, an indication “AUTO” is displayed as the set value of the item “video HDV/DV”, and the indication “D3” is displayed as the set value of the item “component output”. Moreover, for the set value in the individual items, for example, the color of text in the individual items is different from the color of text of the set value for display, whereby a user can easily recognize the set value.

The “OK” button 563 is a button that is pressed down by a user after the user confirms the details of the set value displayed on the set value display part 562 on the set value display screen 560.

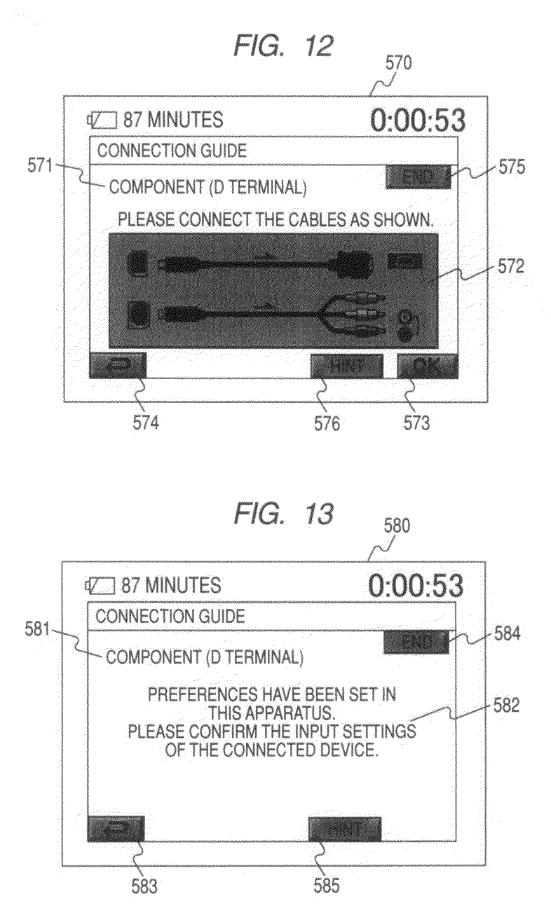

For example, the “OK” button 563 is pressed down when the indication “component (D terminal)” is displayed on the terminal name 551 on the set value display screen 560, and then the set values of the individual items displayed on the set value display part 562 are decided. For example, the item “AUTO” is set as the item “video HDV/DV”, and the item “D3” is set as the item “component output”. In addition, after the “OK” button 563 is pressed down, a connection instruction screen 570 is displayed on the touch panel 140, which displays the connection state using the indication “component (D terminal)”. Moreover, FIG. 12 shows an enlarged connection instruction screen 570.

The connection instruction screen 570 is a connection instruction screen that displays the terminals of the imaging apparatus 100 (the first terminal 310 to the fourth terminal 340) and the terminals of the electronic apparatus selected on the connecting device selection screen 530 or the connect to TV select screen 540 as well as the cables used for connecting these terminals. For example, on the connection instruction screen 570, a terminal name 571, a connecting device display part 572, an “OK” button 573, a return button 574, an end button 575, and a “hint” button 576 are displayed.

The terminal name 571 is a section that displays the name of the terminal selected on the connecting terminal selection screen 550. For example, the indication “component (D terminal)” is displayed thereon.

The connecting device display part 572 is a section that displays the terminals of the imaging apparatus 100 and the terminals of the electronic apparatus selected on the connecting device selection screen 530 or the connect to TV select screen 540 as well as the cables used for connecting these terminals. For example, on the connecting device display part 572, the outer shapes of the terminals of the imaging apparatus 100, the outer shapes of the terminals of the electronic apparatus selected on the connecting device selection screen 530 or the connect to TV select screen 540, and the outer shapes of the cables to connect them are displayed. As described above, terminals and cables are displayed so that a user can visually readily know them, whereby the user can readily understand the terminals and cables necessary or use.

The “OK” button 573 is a button that is pressed down by a user after the terminals of the imaging apparatus 100 are connected to the terminals of the electronic apparatus selected on the connecting device selection screen 530 or the connect to TV select screen 540 with the cables as displayed on the connecting device display part 572.

For example, the “OK” button 573 is pressed down when the indication “component (D terminal)” is displayed on the terminal name 571 on the connection instruction screen 570, and then the connection state confirm screen 580 that confirms the connection state is displayed on the touch panel 140. Moreover, FIG. 13 shows an enlarged connection state confirm screen 580.

Moreover, the “hint” button 576 will be described along with a “hint” button 585 on the connection state confirm screen 580.

The connection state confirm screen 580 is a screen for a user to confirm whether video information or audio information outputted from the imaging apparatus 100 is outputted from the electronic apparatus connected through the cables after the terminals of the imaging apparatus 100 are connected to the terminals of the electronic apparatus selected on the connecting device selection screen 530 or the connect to TV select screen 540 with the cables as displayed on the connecting device display part 572 on the connection instruction screen 570. For example, on the connection state confirm screen 580, a terminal name 581, a confirming message display part 582, a return button 583, an end button 584, and a “hint” button 585 are displayed.

The terminal name 581 is a section that displays the name of the terminal selected on the connecting terminal selection screen 550. For example, the indication “component (D terminal)” is displayed thereon.

The confirming message display part 582 is a section that displays a message for a user to confirm whether video information or audio information outputted from the imaging apparatus 100 is outputted from the electronic apparatus connected through the cables after the terminals of the imaging apparatus 100 are connected to the terminals of the electronic apparatus with the cables. More specifically, in the case in which it is difficult that the imaging apparatus 100 determines whether the imaging apparatus 100 is properly connected to the electronic apparatus, the message is displayed for a user to actually confirm the connection by the user's eyes and ears. For example, on the confirming message display part 582, a message “please confirm the input settings of the connected device” is displayed. As described above, a user is allowed to confirm whether terminals are properly connected to each other after the user finishes connecting the terminals, whereby in the case in which it is difficult to output video and sounds on the electronic apparatus, for example, the return buttons are in turn pressed to trace the connecting work back to find the cause. Accordingly, even a beginner can readily know whether the connecting work is successful.

The “end” button 584 is a button that is pressed down by the user after the imaging apparatus 100 is connected to the electronic apparatus and the connection is confirmed by the user as displayed on the connecting device display part 572.

In other words, the case in which the connection state confirm screen 580 is displayed on the touch panel 140 means the state that all the settings on the main body of the imaging apparatus 100 are ended. In this case, in order to confirm whether the settings of the electronic apparatus to connect are properly made, a confirming message is displayed on the confirming message display part 582 to encourage a user for making a confirmation. This is because there are some electronic apparatuses that are difficult to confirm the output of the electronic apparatus to connect by control signals. Thus, the user confirms the actual operating state.

It is confirmed that the user actually visually sees the output state of the electronic apparatus to connect and video and sounds are outputted from the electronic apparatus to connect with no troubles, the user presses down the “end” button 584 to end the connecting operations. On the other hand, in the case in which video and sounds are not outputted, it can be considered that oversight may occur in the connecting work. Therefore, in the case in which the user returns the previous screen to again make a confirmation, the user presses down the return button 583 to go back to the start screen one by one.

For example, the “end” button 584 is pressed down when the indication “component (D terminal)” is displayed on the terminal name 581 on the connection state confirm screen 580, and then the display screen 510 is displayed on the touch panel 140. Thus, the connecting operations can be ended. After the connecting operations are ended, video can be seen from the electronic apparatus connected to the imaging apparatus 100.

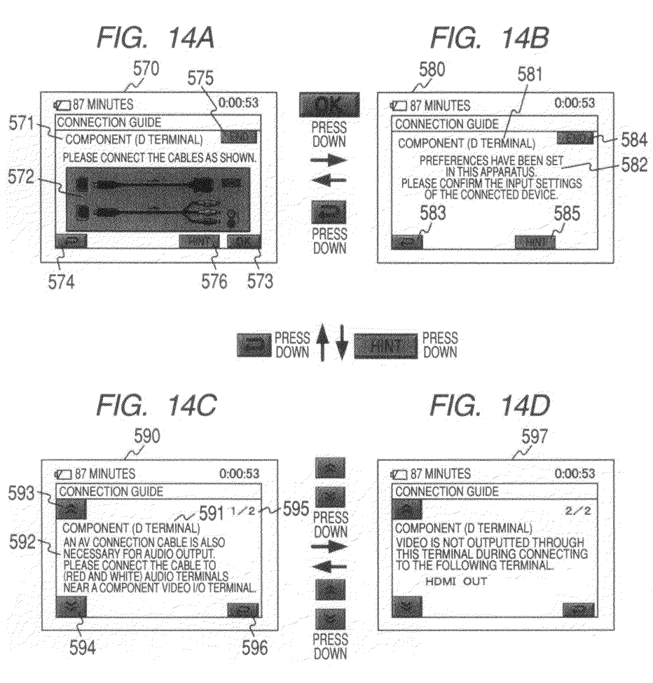

FIGS. 14A to 14D show a diagram depicting an exemplary transition of the display screens displayed on the touch panel 140.

A “hint” button 576 and a “hint” button 585 are buttons that are pressed down to display a hint screen on which hint information is displayed on a connection instruction screen 570 or a connection state confirm screen 580. Moreover, the connection instruction screen 570 shown in FIG. 14A is the same as the connection instruction screen 570 as shown in FIGS. 5 and 12, and the connection state confirm screen 580 shown in FIG. 14B is the same as the connection instruction screen 570 shown in FIGS. 5 and 13.

A hint screen 590 or 597 is a screen that displays hint information for information to be a clue for a user about the targeting terminal and the targeting electronic apparatus when the user has questions on the connection instruction screen 570 or the connection state confirm screen 580, or for information about connections such as the details of important instructions in connection. For example, on the hint screen 590, a terminal name 591, a hint information display part 592, an up-scroll button 593, a down-scroll button 594, a page number 595, and a return button 596 are displayed.

The hint information display part 592 is a section that displays hint information for information to be a clue for solving questions of the terminals displayed on the terminal name 591.

The page number 595 is a number that indicates the page number of the hint screen displayed on the touch panel 140 in all of the hint screens. More specifically, on the hint screen 590 shown in FIG. 14C, an indication “½” is displayed on as the page number 595, and the hint screen 590 displayed on the touch panel 140 is the first page of two hint screens.

Moreover, in the connecting work for terminals, the user presses down the “hint” button to display the hint screen for confirming the details of the hint screen on the connection instruction screen 570 or the connection state confirm screen 580, whereby the user can understand more about the connection.

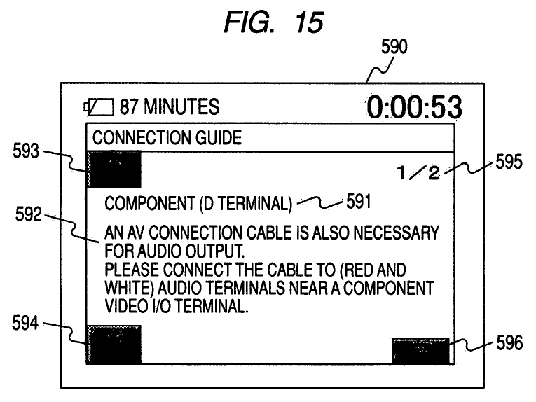

For example, as shown in FIGS. 14A to 14C, the “hint” button 576 or the “hint” button 585 is pressed down on the connection instruction screen 570 or the connection state confirm screen 580, and then the hint screen 590 is displayed. In addition, on the hint screen 590, the up-scroll button 593 or the down-scroll button 594 is pressed down to display the hint screen 597. In addition, on the hint screen 590, the return button 596 is pressed down to display the connection instruction screen 570 that is the screen right before the hint screen 590 or the connection state confirm screen 580. Moreover, FIG. 15 shows an enlarged hint screen 590.

As discussed above, in the connecting work using a plurality of the terminals provided on the imaging apparatus 100, the type of an electronic apparatus to connect and the appearance of terminals to connect are displayed to lead a user to the screen for confirming the connection, and then the user can use the electronic apparatus after the user makes a confirmation. Thus, for a user who does not know the imaging apparatus 100, terminals and cables well, a user who does not read an instruction manual carefully, and a user who uses the imaging apparatus 100 for the first time, they can readily do the connecting work to connect the apparatus 100 to a desired electronic apparatus.

Moreover, in the discussions above, the case is described in which the electronic apparatus that is connected to the imaging apparatus 100 is a high definition device and is connected using the component (D terminal). The cases in which the imaging apparatus 100 is connected to the other electronic apparatuses and in which the imaging apparatus 100 is connected using the other terminals will be described with reference to the drawings.

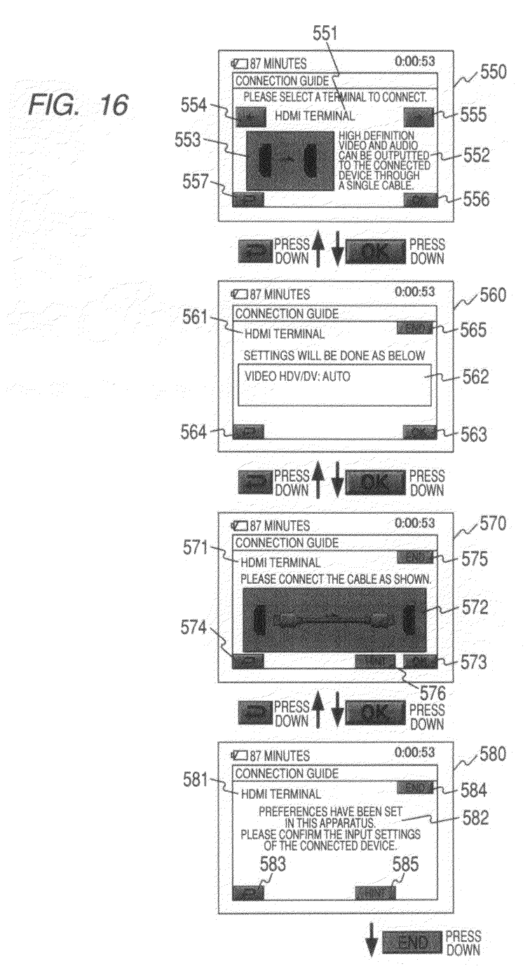

FIGS. 16 to 18 show a diagram depicting an exemplary transition of the display screens displayed on the touch panel 140. A connecting terminal selection screen 550 shown in FIGS. 16 to 18 is a diagram depicting an exemplary display in the case in which the left scroll button 554 or the right scroll button 555 is pressed down on the connecting terminal selection screen 550 shown in FIGS. 5 and 10 to scroll the display screen of the touch panel 140. Moreover, as shown in FIGS. 16 to 18, a set value display screen 560, a connection instruction screen 570, and a connection state confirm screen 580 that are in turn displayed by the manipulation on the connecting terminal selection screen 550 are the same as those shown in FIG. 5. As shown in FIGS. 16 to 18, the connecting operations can be also readily done for the “HDMI terminal”, the “i.LINK terminal (HDV)”, the “component (pin terminal)” as described above.

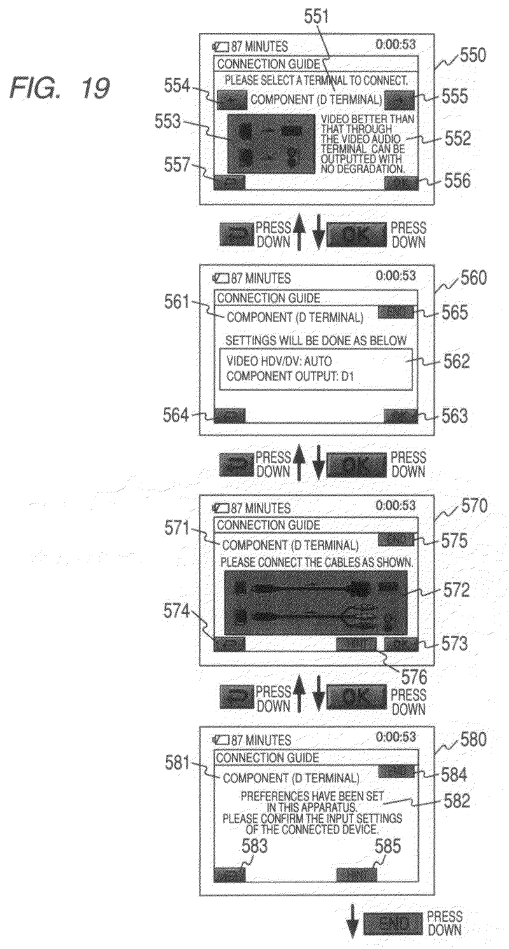

FIGS. 19 to 22 show a diagram depicting an exemplary transition of the display screens displayed on the touch panel 140. A connecting terminal selection screen 550 shown in FIGS. 19 to 22 is a diagram depicting the connecting terminal selection screen 550 displayed when the “other TV” button 542 is pressed down on the connect-to-TV select screen 540 shown in FIGS. 5 and 9. Each of the connecting terminal selection screens 550 shown in FIGS. 19 to 22 is scrolled and displayed by pressing down the left scroll button 554 or the right scroll button 555. In addition, as shown in FIGS. 19 to 22, a set value display screen 560, a connection instruction screen 570, and a connection state confirm screen 580 in turn displayed when the “other TV” button 542 is pressed down on the connect to TV select screen 540 are the same as those shown in FIG. 5.

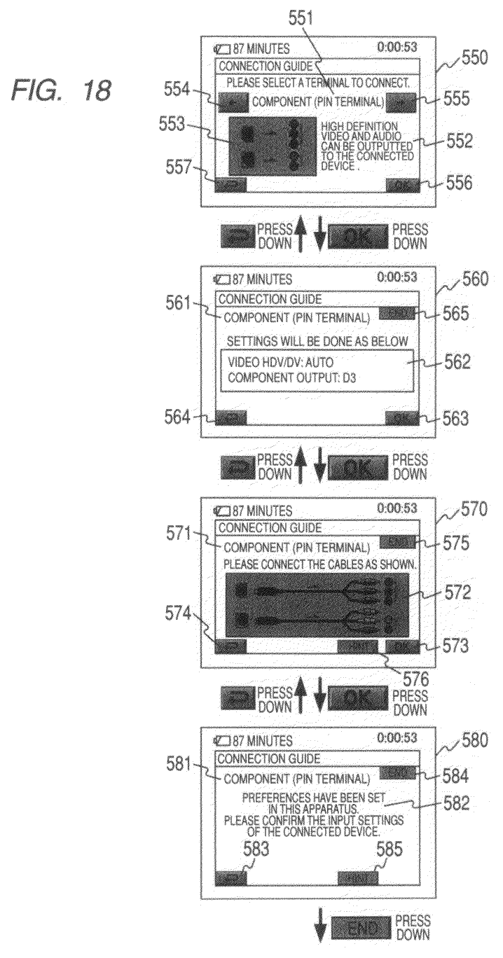

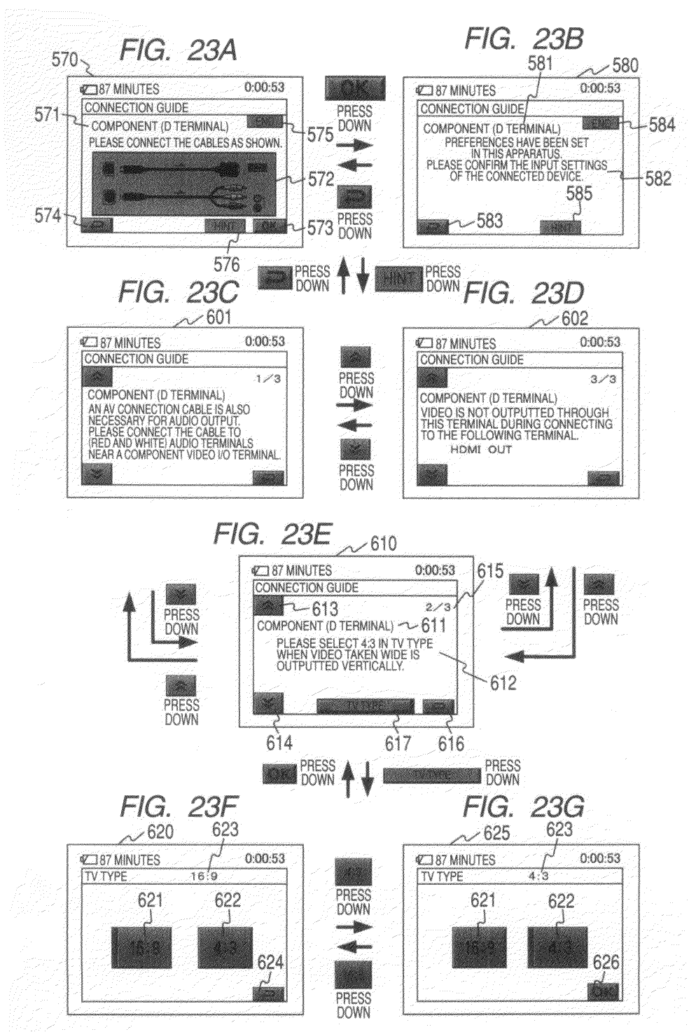

FIGS. 23A to 23G show a diagram depicting an exemplary transition of the display screens displayed on the touch panel 140. A connection instruction screen 570 and a connection state confirm screen 580 shown in FIGS. 23A and 23B are the connection instruction screen 570 and the connection state confirm screen 580 shown in FIG. 18. A “hint” button 576 or 585 is pressed down on the connection instruction screen 570 or the connection state confirm screen 580, and then a hint screen 601 is displayed. An up-scroll button or a down-scroll button is pressed down on the hint screen 601, and then a hint screen 602 or 610 is scrolled and displayed.

Here, in the case in which an electronic apparatus to be connected to the imaging apparatus 100 is a television set other than the high definition television set, the indication “component (D terminal)”, the “S terminal”, or the “video audio terminal” is selected as the connecting terminal, and then a hint screen 610 shown in FIG. 23E is displayed as a hint screen on the connection instruction screen 570 or the connection state confirm screen 580. A “TV type” button 617 is pressed down when the hint screen 610 is displayed, and then a TV type setting screen 620 is displayed. The type of the television set is set on the TV type setting screen 620, whereby adequate video can be outputted to the television set to connect even though video taken by the imaging apparatus 100 is vertically outputted on the television set to connect.

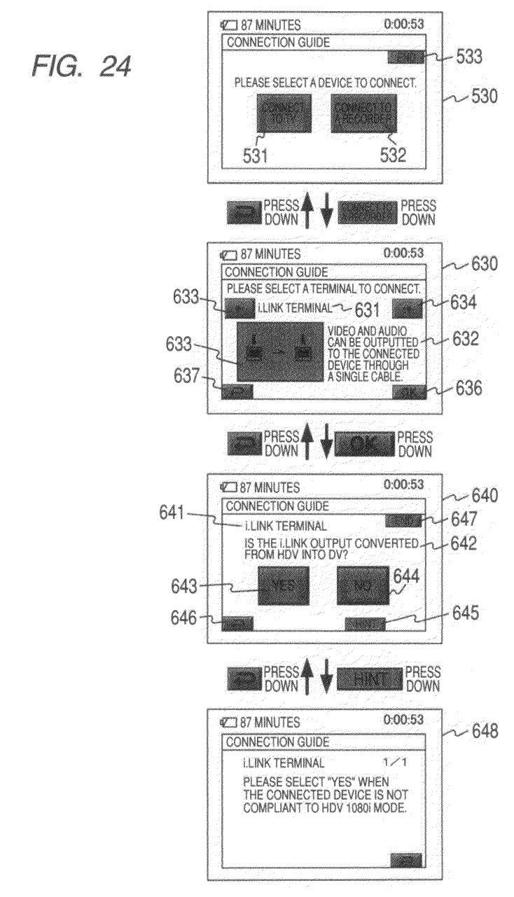

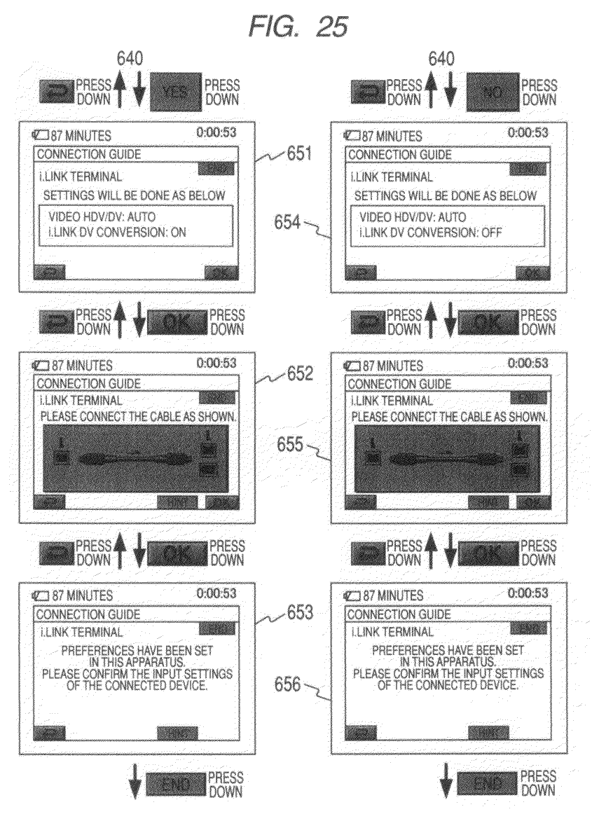

FIGS. 24 and 25 show a diagram depicting an exemplary transition of the display screens displayed on the touch panel 140. A connecting device selection screen 530 shown in FIG. 24 is the connecting device selection screen 530 shown in FIGS. 5 and 8. As shown in FIG. 24, a “connect to recorder” button 532 is pressed down on the connecting device selection screen 530, and then a connecting terminal selection screen 630 shown in FIG. 24 is displayed. Moreover, as the connecting terminal selection screen in this case, a left scroll button 633 or a right scroll button 634 is pressed down to scroll and display a connecting terminal selection screen for the “S terminal” and the “video audio terminal” other than the “i.LINK terminal” shown in FIG. 24. However, the transition on the connecting terminal selection screen for the “S terminal” and the “video audio terminal” is almost the same as that shown in FIG. 5, omitting the descriptions here.

The “OK” button 636 is pressed down when the “i.LINK terminal” is displayed on the terminal name 631 on the connecting terminal selection screen 630, and then a setting screen 640 is displayed which sets whether to convert the i.LINK output from HDV into DV. Here, a “YES” button 643 or a “NO” button 644 is pressed down, and then a set value display part 651 or 654 shown in FIG. 25 is displayed depending on the pressed button. Moreover, the transition after the set value display part 651 or 654 is almost the same as that shown in FIG. 5, omitting the descriptions here. In addition, a “hint” button 645 is pressed down on the setting screen 640, and then a hint screen 648 is displayed.

Next, the connecting operations in the case in which the reproduction mode is set in the imaging apparatus 100 will be described with reference to the drawings. Moreover, here, the case will be described in which a USB (Universal Serial Bus) terminal is provided on the imaging apparatus 100.

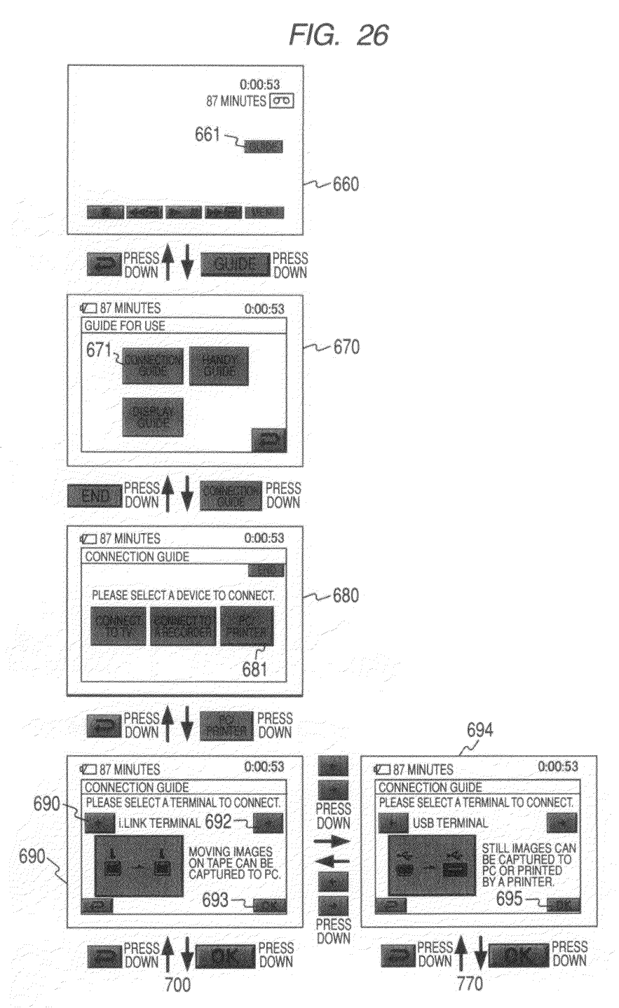

FIGS. 26 to 28 show a diagram depicting an exemplary transition of the display screens displayed on the touch panel 140 in the case in which the reproduction mode is set in the imaging apparatus 100. On a reproduction mode display screen 660 that is the start screen in the case in which the reproduction mode is set in the imaging apparatus 100, a guide button 661 is displayed. Then, the guide button 661 is pressed down on the reproduction mode display screen 660, and then a main guide selection screen 670 is displayed on a touch panel 140. Moreover, the transition to the “i.LINK terminal” after the main guide selection screen 670 is almost the same as the transition described above, omitting the descriptions here.

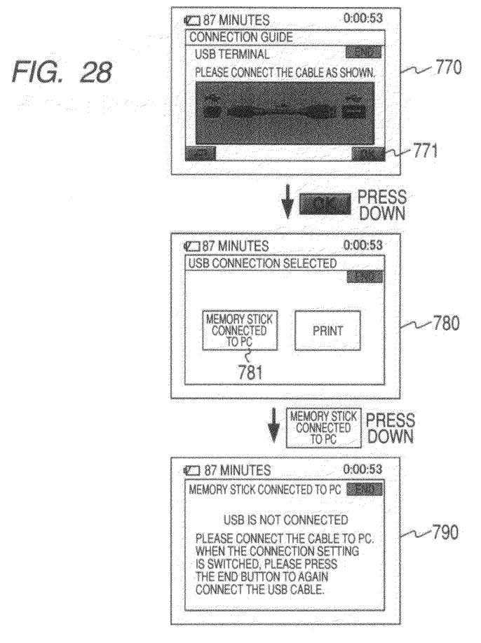

In the case in which an “OK” button 695 is pressed down when “USB terminal” is displayed on a connecting terminal selection screen 694 shown in FIG. 26, it is unnecessary to change the settings. Thus, the set value display screen is not displayed, and a connection instruction screen 770 shown in FIG. 28 is displayed on the touch panel 140. For example, in the case in which an “OK” button 771 is pressed down on the connection instruction screen 770, another function is called to display a USB connection select screen 780 shown in FIG. 28 on the touch panel 140. Then, in the state in which no cable is connected to the USB terminal, a “PC connect” button 781 is pressed down on the USB connection select screen 780, and then a USB unconnected notice screen 790 is displayed on the touch panel 140 to encourage the user to connect a cable to the USB terminal.

Next, the connecting operations will be described with reference to the drawings in the case in which the simple manipulation mode is set in the imaging apparatus 100. The simple manipulation mode is a manipulation mode in which a complicated function is fixed in an automatic manner in order to improve convenience for a user. It is a manipulation mode in which a user is allowed to set only basic functions relatively frequently used (certain functions). For example, in the case in which the simple manipulation mode is set, the user is not allowed to change the settings of the details of the item “video HDV/DV” displayed on the set value display screen.

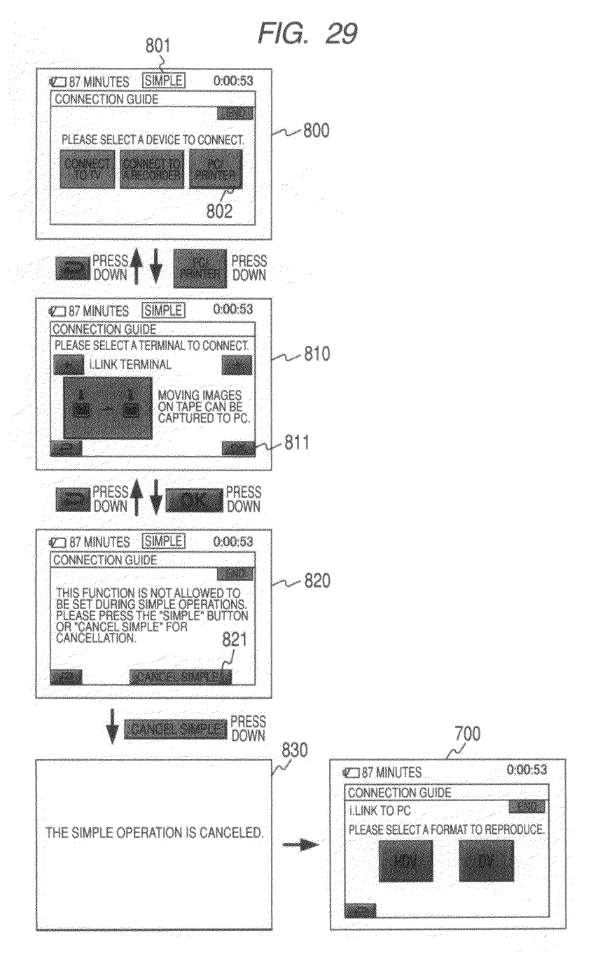

As shown in a connecting device selection screen 800 in FIG. 29, in the case in which the simple manipulation mode is set in the imaging apparatus 100, an indication simple 801 that is an image indicating that the simple manipulation mode is set is displayed on the touch panel 140.

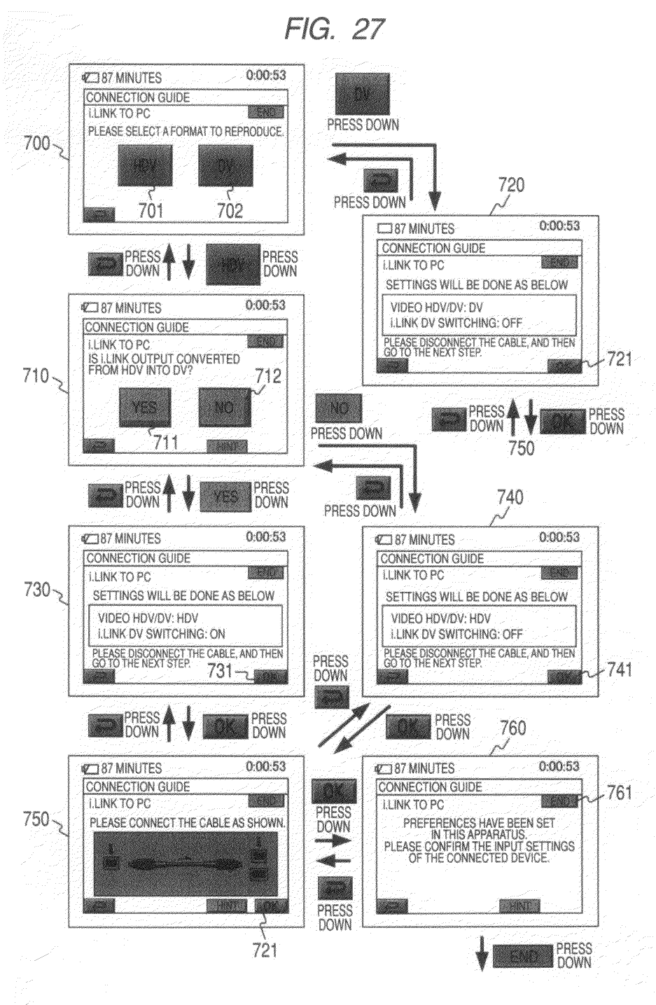

For example, a “PC/printer” button 802 is pressed down on the connecting device selection screen 800, and then a connecting terminal selection screen 810 is displayed on the touch panel 140. An “OK” button 811 is pressed down when “i.LINK terminal” is displayed on the connecting terminal selection screen 810 in the state in which the simple manipulation mode is not set, and then a user goes to a manipulation screen on which it is necessary to change the settings of “video HDV/DV” as shown in FIGS. 26 and 27. Therefore, in the case in which the simple manipulation mode is set, the user is not allowed to go to the manipulation screens after this screen. Then, in the case in which the simple manipulation mode is set, the “OK” button 811 is pressed down when “i.LINK terminal” is displayed on the connecting terminal selection screen 810, and then a simple manipulation mode cancel notice screen 820 is displayed that encourages a user to cancel the simple manipulation mode to make settings on the touch panel 140. A “simple manipulation cancel” button 821 is pressed down on the simple manipulation mode cancel notice screen 820, and then a “simple manipulation is canceled” screen 830 is displayed on the touch panel 140, and a reproduction format select screen 700 shown in FIG. 27 is displayed on the touch panel 140. Moreover, the transition after that is the same as the transition shown in FIG. 27.

Next, another exemplary display displayed on the connecting device display part on the connection instruction screen 570 shown in FIG. 5 will be described with reference to the drawing.

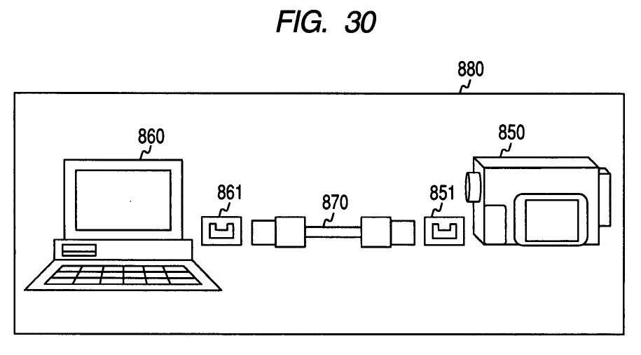

FIG. 30 shows a diagram depicting an exemplary display displayed on a connecting device display part 880.

As shown in FIG. 30, these images may be displayed on the connecting device display part 572 on the connection instruction screen 570 shown in FIG. 5, including an image 851 that depicts the terminal of the imaging apparatus 100, an image 861 that depicts the terminal of an electronic apparatus selected on the connecting device selection screen 530 or the connect to TV select screen 540, an image 850 that depicts the appearance of the imaging apparatus 100 and an image 860 that depicts the appearance of the electronic apparatus, and an image 870 that depicts a cable used for connecting these terminals. Accordingly, a user can more visually easily know terminals and cables, and a user can readily understand the connecting operations.

Next, the operation of the imaging apparatus 100 according to an embodiment of the invention will be described with reference to the drawings.

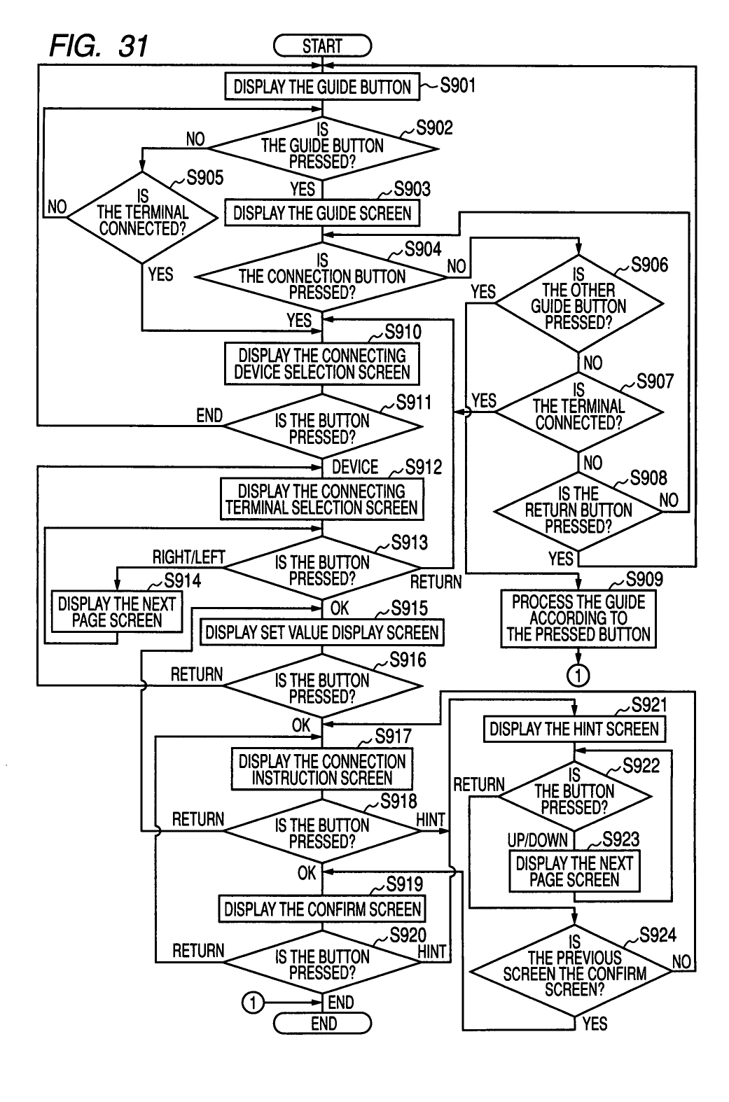

FIG. 31 shows a flow chart depicting the process steps of a terminal connection setting process done by the imaging apparatus 100.

When a power source is turned on (at power-on, and when the power source is started) in the imaging apparatus 100 or when the connection process is ended, as shown in FIG. 5, the guide button 511 is displayed on the touch panel 140 (Step S901).

It is determined whether the guide button 511 is pressed down in the case in which the guide button 511 is displayed on the touch panel 140 (Step S902). If the guide button 511 is pressed down (Step S902), as shown in FIG. 5, the main guide selection screen 520 is displayed (Step S903).

Subsequently, it is determined whether the “connection guide” button 522 is pressed down on the main guide selection screen 520 (Step S904). If the “connection guide” button 522 is not pressed down on the main guide selection screen 520 (Step S904), it is determined whether the guide button other than the “connection guide” button 522 is pressed down on the main guide selection screen 520 (Step S906). If the guide button other than the “connection guide” button 522 is not pressed down on the main guide selection screen 520 (Step S906), it is determined whether cables are connected to the first terminal 310 to the fourth terminal 340 (Step S907).

If no cables are connected to the first terminal 310 to the fourth terminal 340 (Step S907), it is determined whether the return button 525 is pressed down on the main guide selection screen 520 (Step S908). If no cables are connected to the first terminal 310 to the fourth terminal 340 and the return button 525 is not pressed down on the main guide selection screen 520 (Step S907 and S908), the process goes to Step S904, and pressing the button or connecting the cable is monitored (Step S904, and Steps S906 to S908).

If the button other than the “connection guide” button 522 is pressed down on the main guide selection screen 520 (Step S906), the process according to the pressed button is performed (Step S909), and then the operation is ended. For example, if the “shooting guide” button 521 is pressed down on the main guide selection screen 520, various guide screens to go to the setting screen are displayed on the touch panel 140 based on the purpose of the manipulation, and then various setting processes are performed.

Moreover, if the guide button 511 is not pressed down in the case in which the guide button 511 is displayed on the touch panel 140 (Step S902), it is determined whether cables are connected to the first terminal 310 to the fourth terminal 340 (Step S905), the process goes to Step S902, and then pressing the guide button 511 or connecting the cables are monitored (Step S902 and Step S905).

If the “connection guide” button 522 is pressed down on the main guide selection screen 520 (Step S904), or the connection of cables is detected on the first terminal 310 to the fourth terminal 340 (Step S905 and Step S907), the connecting device selection screen 530 is displayed (Step S910).

Subsequently, it is determined whether any one of the buttons is pressed down in the case in which the connecting device selection screen 530 is displayed on the touch panel 140 (Step S911). If the end button 533 is pressed down, the display screen 510 of the start screen is displayed (Step S901). If any one of the buttons for selecting the connecting device is pressed down (Step S911), a connecting terminal selection screen matched with the pressed device is displayed (Step S912). Moreover, here, the case is described in which the “high definition TV” button 541 and the “other TV” button 542 displayed on the connect to TV select screen 540 are displayed on the connecting device selection screen 530 instead of the “connect to TV” button 531 displayed on the connecting device selection screen 530 and any one of the “high definition TV” button 541, the “other TV” button 542 and the “connect to recorder” button 532 is selected on the connecting device selection screen 530. For example, if the “high definition TV” button 541 is pressed down on the connecting device selection screen 530 (Step S911), the connecting terminal selection screen 550 is displayed on the touch panel 140 (Step S912).

Subsequently, it is determined whether any one of the select buttons is pressed down on the connecting terminal selection screen 550 (Step S913). If the left scroll button 554 or the right scroll button 555 is pressed down (Step S913), the previous page or the subsequent page of the connecting terminal selection screen displayed on the touch panel 140 is displayed (Step S914), and then the process goes to Step S913. In addition, if the return button 557 is pressed down on the connecting terminal selection screen 550 (Step S913), the connecting device selection screen 530 is displayed on the touch panel 140 (Step S910).

In addition, if the “OK” button 556 is pressed down on the connecting terminal selection screen 550 (Step S913), the setting details of output to another electronic apparatus to be a target for connection are decided depending on the combination of the type of the another electronic apparatus selected on the connecting device selection screen 530 and the terminals selected on the connecting terminal selection screen 550, and the set value display screen is displayed on the touch panel 140 as the decided setting details (Step S915). For example, if the “OK” button 556 is pressed down in the case in which the indication “component (D terminal)” is displayed on the terminal name 551 on the connecting terminal selection screen 550 (Step S913), the setting details of output to the “high definition television” to be a target for connection are decided in accordance with the indication “component (D terminal)” displayed on the terminal name 551 when pressing the button and the type “high definition television” selected on the connecting device selection screen 530, and the set value display screen 560 relating to the decided setting details is displayed on the touch panel 140 (Step S915).

Subsequently, it is determined whether any one of the select buttons is pressed down on the set value display screen 560 (Step S916). If the return button 564 is pressed down on the set value display screen 560 (Step S916), the connecting terminal selection screen 550 that is displayed right before on the touch panel 140 is displayed (Step S912). On the other hand, if the “OK” button 563 is pressed down on the set value display screen 560 (Step S916), the connection instruction screen 570 is displayed on the touch panel 140 (Step S917). Moreover, if the end button 565 is pressed down on the set value display screen 560, the display screen 510 is displayed on the touch panel 140.

Subsequently, it is determined whether any one of the select buttons is pressed down on the connection instruction screen 570 (Step S918). If the return button 574 is pressed down on the connection instruction screen 570 (Step S918), the set value display screen 560 that is displayed right before on the touch panel 140 is displayed (Step S915). On the other hand, if the “OK” button 573 is pressed down on the connection instruction screen 570 (Step S918), the connection state confirm screen 580 is displayed on the touch panel 140 (Step S919). Moreover, if the end button 575 is pressed down on the connection instruction screen 570, the display screen 510 is displayed on the touch panel 140.

Subsequently, it is determined whether any one of the select buttons is pressed down on the connection state confirm screen 580 (Step S920). If the return button 583 is pressed down on the connection state confirm screen 580 (Step S920), the connection instruction screen 570 that is displayed right before on the touch panel 140 is displayed (Step S917). On the other hand, if the end button 584 is pressed down on the connection state confirm screen 580 (Step S920), the operation of the terminal connection setting process is ended, and then the display screen 510 is displayed on the touch panel 140.

Moreover, if the “hint” button 576 or the “hint” button 585 is pressed down on the connection instruction screen 570 or on the connection state confirm screen 580 (Step S918 and Step S920), the hint screen is displayed on the touch panel 140 (Step S921). For example, if the “hint” button 576 or the “hint” button 585 is pressed down on the connection instruction screen 570 or on the connection state confirm screen 580, the hint screen 590 is displayed. In addition, it is determined whether any one of the select buttons is pressed down on the hint screen (Step S922). If the return button is pressed down on the hint screen (Step S922), the connection instruction screen 570 or the connection state confirm screen 580 that is displayed right before on the touch panel 140 is displayed (Step S924, Step S917, and Step S919). On the other hand, if the up-scroll button 593 or the down-scroll button 594 is pressed down (Step S922), the previous page or the subsequent page of the hint screen displayed on the touch panel 140 is displayed (Step S923), and the process goes to Step S922.

Moreover, in the embodiment, the example is described in which the first terminal 310 to the fourth terminal 340 are provided on the imaging apparatus 100. However, other than these terminals, such terminals may be provided that output various items of information such as video information and audio information.

Moreover, a control terminal may be provided that acquires information on an electronic apparatus to connect and manipulates the electronic apparatus to connect.

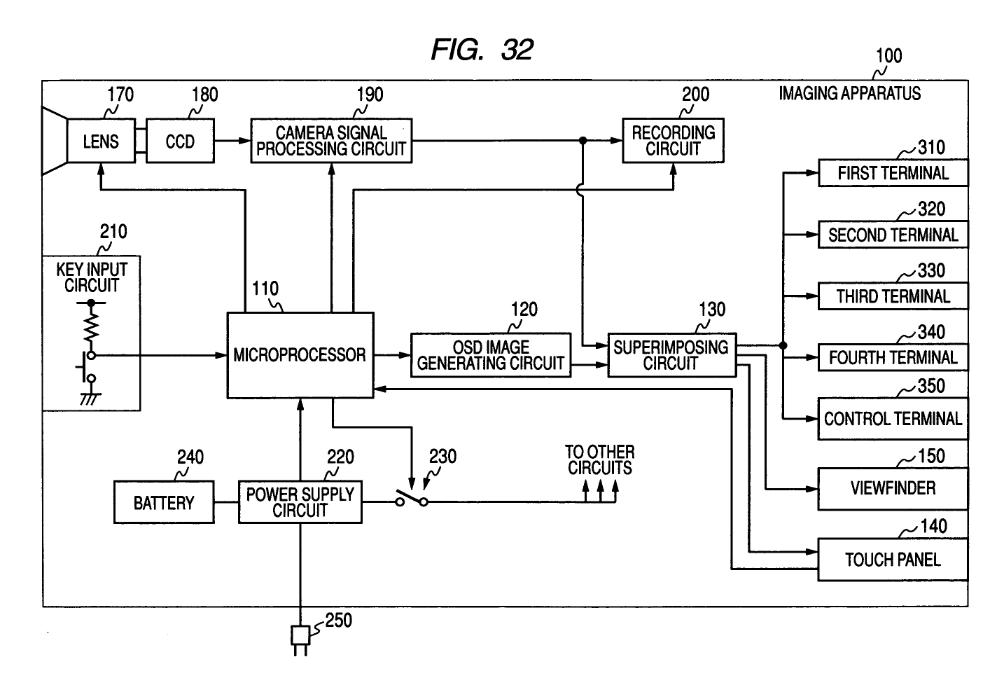

FIG. 32 shows a block diagram depicting an exemplary functional configuration of an imaging apparatus 100 in the case in which a control terminal 350 is provided on the imaging apparatus 100. Moreover, in the imaging apparatus 100 shown in FIG. 32, the configuration other than the provision of the control terminal 350 is the same as the configuration of the imaging apparatus 100 shown in FIG. 1.

In the case in which an electronic apparatus to connect has the same control terminal as the control terminal 350, the control terminal 350 is used to connect the electronic apparatus, whereby the status can be exchanged between the imaging apparatus 100 and the electronic apparatus.

In addition, the connecting operations described above are operations in which a user selects an electric appliance to be a target for connection and terminals for use on the touch panel 140. In contrast to this, in the case of the connecting operations for another electronic apparatus in which the appliance is connected to the control terminal 350 to receive information such as the status, any one of the steps of the connecting operations described above can be omitted. This is because based on the information acquired from the electronic apparatus to connect through the control terminal 350, the output settings on the imaging apparatus 100 side can be changed to the optimum output settings as well as the input settings of the electronic apparatus to connect can be changed from the imaging apparatus 100 side.

In addition, such a scheme may be performed in which at the time when a user connects the control terminal 350 to another electronic apparatus, the terminal suited for connecting to the electronic apparatus is displayed on the touch panel 140 as a connection diagram, the selected input device on the electronic apparatus is set to the terminal displayed, and then the settings of the imaging apparatus 100 are changed to suited ones for the connection.

Moreover, for the control terminal 350, it is unnecessary to provide terminals different from the output terminals, and the first terminal 310 to the fourth terminal 340 may be provided as the control terminal 350. For example, the third terminal (i.LINK OUT) 330 is an output terminal that can exchange video information and audio information as well as various other items of information with another electronic apparatus. Therefore, in stead of providing the control terminal 350, for example, the third terminal (i.LINK OUT) 330 is used to exchange the status with another electronic apparatus.

As described above, for example, the third terminal (i.LINK OUT) 330 is used to connect the imaging apparatus 100 to another electronic apparatus with a single cable as well as the output settings of the imaging apparatus 100, the input settings of the electronic apparatus to connect, or the selection of the input device can be done collectively. In the case in which the apparatus 100 is connected to the appliance in this manner, information on both sides can be exchanged at the time when a user finishes connecting the cable. Thus, for the process steps of the connecting operations, an electronic apparatus to connect is selected, the terminal is selected on the imaging apparatus 100 side on the touch panel 140, a connection diagram is displayed on the touch panel 140, and then the screen is displayed that encourages a user to connect the imaging apparatus 100 to the electronic apparatus to connect. Such a process step can be considered that at the time when the imaging apparatus 100 is connected to the electronic apparatus after the diagram is displayed, the settings of the apparatus and the device are automatically changed.

In addition, in the case in which a cable is connected to the output terminal that can exchange the status with another electronic apparatus, such a scheme may be performed in which a screen that encourages a user to connect another electronic apparatus is displayed on the touch panel 140, the status is exchanged at the time when the connection to another electronic apparatus is established, and then the settings optimum on the apparatus and on the device are automatically set.

Moreover, according to an embodiment of the invention, the imaging apparatus is described as an electronic apparatus. However, an embodiment of the invention can be adapted to electronic apparatuses such as a cellular telephone, a reproduction device and a recorder other than the imaging apparatus. In addition, in an embodiment of the invention, the case is described in which a plurality of the terminals provided on the electronic apparatus is output terminals. However, an embodiment of the invention can be adapted as well to the case in which a plurality of the terminals provided on the electronic apparatus is input terminals. Moreover, in an embodiment of the invention, the case is described in which information outputted from the electronic apparatus is video information or audio information. However, an embodiment of the invention can be adapted as well to the case in which information outputted from the electronic apparatus is other information such as text data.

As discussed above, an embodiment of the invention allows the connection to another electronic apparatus using an output method desired by a user in an electronic apparatus provided with a plurality of terminals that input or output video information or audio information. In addition, the screen indications on the imaging apparatus 100 are used to describe the connecting method for a user. Moreover, the set items relating to the individual terminals to which a user used to make settings by him/herself can be automatically changed in accordance with the output method desired by the user.

In addition, a user can expand knowledge about the method of connecting another electronic apparatus. Moreover, a user can find the method of connecting another electronic apparatus during the connecting work that the user does not know before. In addition, a user can find the method of connecting another electronic apparatus different from the connecting method that the user used to do. Then, the user can readily use the connecting method thus found. In addition, a user can confirm the method of connecting another electronic apparatus any time.

As described above, according to an embodiment of the invention, in the case in which an electronic apparatus is connected to another electronic apparatus, the connecting operations can be made easier.

Moreover, an embodiment of the invention is an exemplary implementation of an embodiment of the invention, which has correspondences with descriptions in claims. However, an embodiment of the invention is not restricted thereto, which can be modified variously with in the scope of the teachings of an embodiment of the invention.

In other words, for example, an electronic apparatus corresponds to the imaging apparatus 100. In addition, for example, an imaging apparatus corresponds to the imaging apparatus 100.

In addition, for example, a connecting appliance selecting means corresponds to the connecting appliance selecting part 420. In addition, for example, a connecting terminal selecting means corresponds to the connecting terminal selecting part 430.

In addition, for example, a setting detail deciding means corresponds to the setting detail deciding part 440.

In addition, for example, a display means corresponds to the touch panel 140.

In addition, for example, the display control means corresponds to the display control part 450.

In addition, for example, a connecting device selection screen corresponds to the connecting device selection screen 530.

In addition, for example, a connecting terminal selection screen corresponds to the connecting terminal selection screen 550.

In addition, for example, a connection instruction screen corresponds to the connection instruction screen 570.

In addition, for example, a connection state confirm screen corresponds to the connection state confirm screen 580.

In addition, for example, a setting detail display screen corresponds to the set value display screen 560.

In addition, for example, a hint screen corresponds to the hint screen 590.

In addition, for example, a guide screen corresponds to the main guide selection screen 520.

In addition, for example, a start screen corresponds to the display screen 510.

In addition, a guide button corresponds to the guide button 511.

In addition, for example, a detecting means corresponds to the connection detecting part 470.

In addition, for example, the step of selecting a connecting device corresponds to Step S911. In addition, for example, the step of selecting a connecting terminal corresponds to Step S913. In addition, for example, the step of deciding setting details corresponds to Step S915.

Moreover, the process steps described in an embodiment of the invention may be considered to be a method having a series of these process steps. In addition, they may be considered to be a program which allows a computer to execute a series of these process steps and a recording medium on which the program is stored.

It should be understood by those skilled in the art that various modifications, combinations, sub-combinations and alterations may occur depending on design requirements and other factors insofar as they are within the scope of the appended claims or the equivalents thereof.

1. An electronic apparatus comprising:
a plurality of terminals that output a predetermined item of information;
a connecting appliance selecting means for selecting a type of another electronic apparatus to be a target for connection among other electronic apparatuses having a terminal connectable to at least a single terminal among the plurality of the terminals through a predetermined communication means;
a connecting terminal selecting means for selecting a combination of terminals used for connection from combinations of terminals provided on the electronic apparatus and terminals provided on the selected type of another electronic apparatus; and
a setting detail deciding means for deciding setting details of output to the another electronic apparatus in accordance with the type of the selected another electronic apparatus and the combination of the terminals.

2. The electronic apparatus according to claim 1, further comprising:
a display means for displaying various screens; and
a display control means for displaying a connecting device selection screen for selecting the another electronic apparatus on the display means and for displaying a connecting terminal selection screen for selecting a combination of terminals provided on the electronic apparatus and terminals provided on the selected type of another electronic apparatus on the display means,
wherein the connecting appliance selecting means selects a type of another electronic apparatus to be a target for connection among other electronic apparatuses displayed on the connecting device selection screen, and
the connecting terminal selecting means selects a combination of terminals used for connection from combinations of terminals displayed on the connecting terminal selection screen.

3. The electronic apparatus according to claim 2, wherein the display control means allows the display means to display a connection instruction screen that displays the appearance of terminals for the selected combination and the appearance of a communication means connectable to these terminals to encourage connection of these terminals to the communication means.

4. The electronic apparatus according to claim 3, wherein the display control means allows the display means to display a connection state confirm screen that encourages confirmation of a connection state between the electronic apparatus and the selected another electronic apparatus connected through the terminals and the communication means displayed on the connection instruction screen.

5. The electronic apparatus according to claim 3, wherein on the connection instruction screen, the appearance of the electronic apparatus and the appearance of the selected another electronic apparatus are displayed as well as the appearance of the terminals and the appearance of the communication means.

6. The electronic apparatus according to claim 2, wherein the display control means allows the display means to display a setting detail display screen that displays the setting details decided by the setting detail deciding means to allow a user to confirm the setting details.

7. The electronic apparatus according to claim 2, wherein the display means is a touch panel that displays select buttons for guiding a user to a predetermined screen on various screens.

8. The electronic apparatus according to claim 7, wherein the display control means displays a hint screen that displays hint information to be information about details displayed on the touch panel based on pressing a select button displayed on the touch panel.

9. The electronic apparatus according to claim 7, wherein the display control means displays a guide screen that displays a select button for the purpose of at least manipulation to guide a user to the connecting device selection screen on the touch panel.

10. The electronic apparatus according to claim 9, wherein on a start screen of the touch panel, a guide button is displayed that is a select button to go to the guide screen.

11. The electronic apparatus according to claim 2, wherein on the connecting terminal selection screen, descriptions relating to terminals provided on the electronic apparatus and terminals provided on the selected type of another electronic apparatus are displayed.

12. The electronic apparatus according to claim 1, wherein the predetermined item of information is video information or audio information.

13. The electronic apparatus according to claim 2, further comprising a detecting means for detecting an event that a communication means is connected to at least a single terminal among the plurality of the terminals,
wherein the display control means allows the display means to display the connecting device selection screen when the connection of a communication means is detected by the detecting means.

14. An electronic apparatus comprising:
a plurality of terminals to which a predetermined item of information is input;
a connecting appliance selecting means for selecting a type of another electronic apparatus to be a target for connection among other electronic apparatuses having a terminal connectable to at least a single terminal among the plurality of the terminals through a predetermined communication means;
a connecting terminal selecting means for selecting a combination of terminals used for connection from combinations of terminals provided on the electronic apparatus and terminals provided on the selected type of another electronic apparatus; and
a setting detail deciding means for deciding setting details of input from the another electronic apparatus in accordance with the type of the selected another electronic apparatus and the combination of the terminals.

15. An imaging apparatus comprising:
a plurality of terminals that output a predetermined item of information;
a connecting appliance selecting means for selecting a type of another electronic apparatus to be a target for connection among other electronic apparatuses having a terminal connectable to at least a single terminal among the plurality of the terminals through a predetermined communication means;
a connecting terminal selecting means for selecting a combination of terminals used for connection from combinations of terminals provided on the imaging apparatus and terminals provided on the selected type of another electronic apparatus; and
a setting detail deciding means for deciding setting details of output to the another electronic apparatus in accordance with the type of the selected another electronic apparatus and the combination of the terminals.

16. A display control method for use in an electronic apparatus having a plurality of terminals that output a predetermined item of information, the method comprising:
selecting a type of another electronic apparatus to be a target for connection among other electronic apparatuses having a terminal connectable to at least a single terminal among the plurality of the terminals through a predetermined communication means;
selecting a combination of terminals used for connection from combinations of terminals provided on the electronic apparatus and terminals provided on the selected type of another electronic apparatus; and
deciding setting details of output to the another electronic apparatus in accordance with the type of the selected another electronic apparatus and the combination of the terminals.

17. A program which allows a computer to execute a method in an electronic apparatus having a plurality of terminals that output a predetermined item of information, the method comprising:
selecting a type of another electronic apparatus to be a target for connection among other electronic apparatuses having a terminal connectable to at least a single terminal among the plurality of the terminals through a predetermined communication means;
selecting a combination of terminals used for connection from combinations of terminals provided on the electronic apparatus and terminals provided on the selected type of another electronic apparatus; and
deciding setting details of output to the another electronic apparatus in accordance with the type of the selected another electronic apparatus and the combination of the terminals.

18. An electronic apparatus comprising:
a plurality of terminals that output a predetermined item of information;
a connecting appliance selecting unit configured to select a type of another electronic apparatus to be a target for connection among other electronic apparatuses having a terminal connectable to at least a single terminal among the plurality of the terminals through a predetermined communication unit;
a connecting terminal selecting unit configured to select a combination of terminals used for connection from combinations of terminals provided on the electronic apparatus and terminals provided on the selected type of another electronic apparatus; and
a setting detail deciding unit configured to decide setting details of output to the another electronic apparatus in accordance with the type of the selected another electronic apparatus and the combination of the terminals.

19. An electronic apparatus comprising:
a plurality of terminals to which a predetermined item of information is input;
a connecting appliance selecting unit configured to select a type of another electronic apparatus to be a target for connection among other electronic apparatuses having a terminal connectable to at least a single terminal among the plurality of the terminals through a predetermined communication unit;
a connecting terminal selecting unit configured to select a combination of terminals used for connection from combinations of terminals provided on the electronic apparatus and terminals provided on the selected type of another electronic apparatus; and
a setting detail deciding unit configured to decide setting details of input from the another electronic apparatus in accordance with the type of the selected another electronic apparatus and the combination of the terminals.
